(19) United States
(12) Patent Application Publication
(10) Pub. No.: US 2018/0001684 A1
(43) Pub. Date: Jan. 4, 2018

(54) Multizone On-Demand Printable Construct

(71) Applicant: WS Packaging Group, Inc., Green Bay, WI (US)

(72) Inventors: Chauncey T. Mitchell, Jr., Lakeland, TN (US); Patrick A. Young, Appleton, WI (US)

(21) Appl. No.: 15/545,648

(22) PCT Filed: Jan. 21, 2016
(86) PCT No.: PCT/US2016/014350

§ 371 Date: Jul. 21, 2017

Related U.S. Application Data
(60) Provisional application No. 62/106,650, filed on Jan. 22, 2015.
(60) Provisional application No. 62/261,700, filed on Dec. 1, 2015.

(51) Int. Cl. B41M 3/00; A63F 3/06; B41M 5/42; B41M 5/41; B41M 5/30

(52) U.S. Cl. CPC B41M 3/005; B41M 5/41; B41M 5/30; B41M 5/42; A63F 3/0665; A63F 2003/0675; B41M 2205/04

(57) ABSTRACT

A laminated construct such as a ticket or game piece includes an internal on-demand thermally printable layer hidden between substantially opaque substrates. One of the substrates is a metallized film and the other substrate is a direct thermal print medium. The construct can be arranged in various ways including an arrangement for presenting some thermally printed information for immediate viewing and other thermally printed information that is temporarily hidden from view beneath the metallized film. The arrangements include arranging the metallized film as a plurality of island that are individually peelable apart from the direct thermal print medium for revealing the temporarily hidden information.

### TECHNICAL FIELD

The invention relates to laminated constructs having an internal on-demand thermally printable layer hidden between substantially opaque substrates. Information is thermally printed in the internal layer through one of the substantially opaque substrates. The substrates can be at least partly separated for revealing the information that is on-demand printed in the internal layer.

### BACKGROUND

Laminated constructs with hidden internal layers that can be printed on demand, where on-demand printed results remain temporarily hidden until the constructs are opened. For instance, the laminated constructs can take the form of game pieces in which a player can interact directly or indirectly with a gaming machine in a prescribed manner, and such game pieces printed as a result of the interaction can be dispensed. Information printed in an internal layer of the game piece, such as text or other graphics, remains hidden until the player opens the game piece. The internal layer can be mounted on an inner face of a first substantially opaque substrate and can be covered by a second substantially opaque substrate. The substantially opaque nature of the substrates renders information printed in the internal layer hidden from view under ordinary unaided viewing and lighting conditions. The two substrates can be laminated together in a way that does not preclude their at least partial separation. The game piece is opened by at least partially separating the two substantially opaque substrates without shearing or otherwise damaging the printed internal layer that remains on one of the substantially opaque substrates.

The on-demand printed constructs of this type provide increased security over preprinted game pieces with hidden information printed on one substantially opaque substrate and covered by either a peelable substantially opaque substrate or a substantially opaque scratch-off wax, latex ink, or other coating. Extra care is required to assure that the preprinted information remains hidden from the time the game pieces are first printed at one site to the time game pieces are dispensed at another site. On-demand printed game pieces have little or no added value until demand printed and dispensed on site. A programmable central computer system connected to one or more remote gaming machines via encrypted lines of communication can upon verification of an acceptable input, such as the insertion of cash or a cash equivalent into a remote gaming machine, transmit instructions to the individual gaming machines for printing hidden results according a predetermined algorithm or pattern.

One example of such a construct in the form of a pull tab game piece is disclosed in co-assigned U.S. Pat. No. 6,543,808 of Mitchell, Jr. et al. A base substrate of the pull tab game piece is at least partially transparent. A thermosensitive imaging layer overlays a front surface of the base substrate, and a substantially opaque coating covers the thermosensitive imaging layer. A cover, within which one or more peelable pull tabs are formed, is bonded to a back surface of the substrate. The thermosensitive imaging layer can be direct thermal printed through the substantially opaque coating. When the one or more pull tabs are peeled back, the direct thermal printing is visible through the at least partially transparent base substrate.

Another such construct presented in the form of a ticket is disclosed in co-assigned U.S. Pat. No. 8,546,301 of Ribi et al. Cover and base substantially opaque substrates straddle a thermally sensitive medium, which is thermally printable through one of the substrates. In a preferred embodiment, the cover substrate is a metallized film through which the thermally sensitive medium can be direct thermal printed. An adhesive layer bonds the two substrates together but is excluded from regions intended for thermal printing. Corner tabs die cut through the base substrate assist with the separation of the two substrates for revealing the thermal printing. The adhesive bonds are broken during the separation of the substrates evidencing that the ticket has been opened. Confusion patterns can be formed on both substrates to further obscure the printed contents of the tickets. For example, a first confusion pattern can be printed on the base substrate and a second confusion pattern can be embossed in the metallized film of the cover substrate or printed on one or both sides of the cover substrate.

Although the prior on-demand printable constructs offer significant security advantages over preprinted game pieces, the mechanisms of the on-demand printable constructs for revealing information differ significantly from the more popular scratch-off mechanisms of the preprinted game pieces. In addition, the prior on-demand printable constructs have not fully exploited structural and functional differences that are useful for performance enhancements.

### SUMMARY

The invention as contemplated for certain embodiments provides a direct thermal printable construct that includes a cover substrate comprising a metallized film and a base substrate comprising a thermally printable medium including a thermosensitive imaging layer subject to color change by thermal printing. The cover substrate is divided into a plurality of islands of metallized film that are individually releasably bonded to the base substrate. The thermosensitive imaging layer is thermally printable by exposing the plurality of islands of metallized film to localized heat and pressure of a thermal printhead for inducing local changes in the color of the thermosensitive imaging layer that is obscured from view by the plurality of islands of metallized film. The islands of metallized film are individually peelable off the base substrate for revealing the local changes in the color of the thermosensitive imaging layer.

The plurality of islands of metallized film are preferably releasably bonded to the base substrate by a clean-release adhesive that can be composed of a layer of solvent-based release and an adjoining layer of water-based cold glue. As such, the islands of metallized film are peelable off of the base substrate without leaving a tacky residue on either the islands of metallized film or the base substrate. Heat from a thermal printer for imaging the thermosensitive imaging layer transmits through both the metallized film and the releasable bond that temporarily holds the islands in place on the base substrate.

Preferably, the thermosensitive imaging layer includes first areas that are covered by the plurality of islands of the metallized film and second areas that are not covered by the plurality of islands of the metallized film. The second areas of the thermosensitive imaging layer that are not covered by the islands of metallized film are thermally printable by more directly exposing the thermosensitive imaging layer to localized heat and pressure of the thermal printhead for inducing local changes in the color of the thermosensitive imaging layer that are not obscured from view by the plurality of islands of metallized film. The exposed second areas can also be preprinted by conventional ink transfers, e.g., flexographic, ink jet or laser printer.

The plurality of islands can be formed by die cutting ovals or other closed-form shapes through the cover substrate, which can be initially bonded to the base substrate with the clean-release adhesive in the form of a sheet or more preferably a web. Following a die cutting operation outlining the plurality of islands, a surrounding matrix comprising a remaining portion of the cover substrate can be removed, leaving the plurality of islands individually bonded to the base substrate. The clean-release adhesive can be flood coated or can be pattern coated such as in registration with the areas occupied by the islands. The islands can be alternatively shaped as other geometric forms such as circles, triangles, rectangles, diamonds, trapezoids, and polygons and other familiar shapes such as stars, hearts, crescents, eggs, and clouds, as well as more fanciful or irregular shapes that might be associated with the intentions for printing the construct or the islands themselves including faces, cars, and other objects or symbols. In addition, the islands can be displaced from one another or clustered in the form of complementary shapes separated by the die cuts.

The locations of the individual islands are preferably preplanned or otherwise made identifiable to a thermal printer for registering on-demand thermal printing of the information intended to be temporarily hidden by the islands. For example, the individual constructs, such as in the form of game pieces, can be encoded at the time of manufacture, such as by preprinting codes or registration marks, for identifying the relative locations of the islands on the game pieces, and a reader or other sensor can be associated with the on-demand thermal printer for printing the intended hidden information at these locations. Preprinted encoding can also be used to distinguish different games of play, such as by identifying particular types or batches game pieces to a central processor so that a single on-demand printer can be used for printing and dispensing game pieces associated with different games.

In addition to die cutting the outer peripheral shapes of the islands to isolate the individual islands from each other or the remaining matrix, the islands can be further die cut or “fractured” such that the islands tend to separate into pieces when removed to expose underlying thermal printing. The additional die cuts are preferably composed of a plurality of straight or curved lines or closed shapes. The islands can be circumscribed and internally fractured in one or more die cutting stages. For example, the islands can be circumscribed by a first die strike and can be internally fractured by a second die strike. A portion of the internal fracturing could also be accomplished by the first die strike or a third die strike could be used for additionally fracturing the islands, including cutting overlapping fracturing patterns in the islands. The order of the strikes can also be varied.

The internal fracturing preferably divides the islands into disconnected sections, such that the sections are individually removable from the base substrate. Thus, the individual islands are removable in pieces for progressively revealing the underlying printing in stages. Alternatively, the islands can be divided into sections that remain at least partially interconnected so that the removal of the islands is still accomplished in stages but the interconnected sections remain together upon removal. The fractured islands are generally more easily removable in pieces than islands that are not fractured.

The fracture patterns can vary among the islands mounted on a common substrate so that the way in which the islands are disassembled to reveal underlying printing is less predictable for enhancing the removal experience (e.g., suspense) of players. The successive removal of island sections allows the information contained in the underlying printing to be revealed in stages. For example the island sections can be sized, shaped, and registered with intended print locations so that multiple sections cover portions of the printing required to convey their embodied information. For example, the sections can be sized, shaped, and registered to overlay the intended locations of different printed characters or symbols, such that the removal of no one section fully reveals the embodied information. In addition, the fractured sections can be reduced in size and can be more densely packed together so that the sections are removable in the form approaching the removal experience of a more traditional latex/wax “scratch-off” covering. The fracture patterns can also be coordinated with the peripheral shapes of the islands to be further representative of objects, such as stars, bullseyes, flowers, cars, trucks, and animals, where the internally cut lines contribute to the definitions of the objects.

Although, at least the die cutting operation for circumscribing the islands takes place before the surrounding matrix is removed, one or more additional die cutting operations for fracturing the islands can take place either before or after the matrix is removed. Either before or after the matrix is removed, a fracturing pattern could be impressed into the surface of the base substrate that supports the islands as a form of embossing or debossing. For example a rotary die could be spaced to track along the advancing length of the base substrate cutting through the islands but leaving only strike marks in the base substrate. Thus, the fracturing pattern can be extended beyond the islands over the underlying substrate to provide a more uniform or textured appearance.

The orientation of the die cuts as well as the size and shape of the cut sections of the islands within the fracturing patterns can be chosen to avoid unwanted interference with a thermal printhead. Particularly with respect to the relative direction of printhead travel over the islands or the periphery of the islands over which the printhead relatively travels, the die cuts can be arranged to avoid loose edges or other irregularities that might catch on the printhead, leading to the premature or inadvertent removal of one or more sections of the islands. For example, the cut lines can be oriented traverse or otherwise inclined to the relative direction of printhead travel to allow contact with the printhead while the individual sections of the islands remain affixed to the underlying substrate.

Within individual die cutting strikes, the fracturing patterns cut by the dies are preferably arranged to avoid engagements with the die that could inadvertently lift sections of the islands from their underlying substrate. For example, the cutting edges of the die can be spaced and relatively oriented to avoid intersections that might pull corners of the sections apart from the underlying substrate. Additional die-cutting stages can be used for cutting intersecting lines that might otherwise cause unwanted separations if fashioned within the strike pattern of a single die. A varnish or similar coating can be applied over the fractured islands to further protect the island segments during thermal printing.

The fracturing patterns can also be arranged to form or otherwise contribute to confusion patterns for obscuring the effects of branding or reduce the effectiveness of candling. Alternatively or additionally, the effects of branding can be reduced or eliminated by using heat-stabilized films for supporting metallized layers. The fracturing patterns themselves can produce a confusion patterns, and the dies can be heated for locally branding heat-sensitive metallized film cover substrates from which the islands are cut or for imaging the fracturing patterns on the underlying thermosensitive substrates. While the island shapes and their fracture patterns have been described as having been die cut through the cover substrate 52, other cutting mechanisms can be used to similar effect such as laser cutting or etching.

While the fractured islands have been described as removable overlays through which an underlying substrate can be on-demand printed, such as at a point of distribution, the fractured islands can also be used as removable overlays for preprinted substrates. For example, the fractured islands of metallized film can be used as replacements for more traditional latex/wax-based scratch off coverings. The fracturing can be used to both obscure the preprinted underlying contents and to provide for progressively revealing the underlying contents by a scratching or other peeling action imparted by a player, such as by using a fingernail, coin, or other tool. In addition, the areas of the thermally printable medium base substrate beneath the islands can be preprinted in part on press during manufacture and later on-demand thermally printed through the islands.

The fractured islands can also contribute to tamper evidency. While whole islands of metallized film tend to crumple upon removal, the fractured islands also tend to separate into multiple parts that are damaged upon removal and can be much more difficult to restore to their original form as die cut in place. Minor connections, such as the ties of a perforation pattern, can be provided between some or all of the sections to provide further evidence that the fractured islands have been removed. The ties can be designed to rupture between the sections or to distort themselves or their adjoining sections so that restoring the fractured islands to their original form becomes more difficult.

Similar ties between sections of the fractured islands can also be used to clump the sections of the fractured islands together upon removal so that the islands can be discarded as whole or more substantial pieces. The ties are preferably arranged so that the sections remain progressively removable to preserve player suspense but remain interconnected for more efficient disposal.

Other embodiments describe a direct thermal printable construct having a thermosensitive imaging layer carried on a base substrate that is at least partially covered by a cover substrate in the form of a metallized film. A clean-release adhesive layer releasably bonds the two substrates together. A confusion pattern is printed over a first area of the metallized film while a second area of the metallized film remains exposed without a confusion pattern. The thermosensitive imaging layer is printable by exposing the first and second areas of the metallized film to localized heat and pressure of a thermal printhead for inducing local changes in the color of the thermosensitive imaging layer. Single or multiple color changes in the thermosensitive imaging layer can be effected between different areas of the base substrate or within the same area of the base substrate such as by regulating the printing temperature. The second area of the metallized film is printable by the exposure of the metallized film to the localized heat and pressure of the thermal printhead for inducing local changes in the reflectivity of the metallized film.

The confusion pattern printed over the first area of the metallized film preferably incorporates variations in reflectivity to obscure the local reflectivity changes in the metallized film. For example, the variations in the reflectivity of the confusion pattern include variations in gloss. In this way, a portion of the thermal printing remains hidden in the thermosensitive imaging layer beneath the metallized film and another portion of the thermal printing is visible as local variations in the reflectivity characteristics of the metallized film. Confusion patterns applied as inks can also exploit variations in ink density to obscure underlying information.

For some embodiments, the cover substrate is preferably a metallized film that is at least partially subject to the branding effects of a thermal printer. The clean-release adhesive layer releasably bonds the two substrates together, even in the region intended for direct thermal printing, but is releasable, preferably in a dry non-tacky fashion, to allow at least partial separation of the two substrates. Preferably, the clean-release adhesive layer is composed of a layer of solvent-based release and an adjoining layer of water-based cold glue.

Both the first areas over which the confusion pattern is printed and the second areas over which the confusion pattern is not printed can be exposed to direct thermal printing. Corresponding print patterns are formed in the thermosensitive imaging layer underlying both the first and second areas. Although not in the form of a printed ink, visible print patterns are formed in the second areas of the metallized film exposed to the direct thermal printing.

The direct thermal printing in the second areas of the metallized film changes the reflectivity characteristics of the metallized film so as to render the thermally printed pattern visible on the cover substrate. For example, the localized heating effects of the direct thermal printing can locally change the reflectivity characteristics of the metallized film such that the locally heated areas exhibit more diffuse reflection than the surrounding areas of the metallized film that are not similarly exposed to heat. The first areas over which the confusion pattern is printed are at least partially protected by the confusion pattern, and the confusion pattern itself can be arranged to obscure any underlying contrasts in reflectivity, such as by using one or more printing inks that vary in gloss (e.g., such as between gloss and satin or between satin and flat). Thus, the direct thermal printing has the effect of producing images that are visible in the second areas of the metallized film cover substrate while the same images also remain hidden in the underlying thermosensitive imaging layer.

A clear varnish can be applied over the printed confusion pattern to reduce friction and surface irregularities that could interfere with the operation of a thermal printhead. Patterned die cuts or other features can be used to assist a player or other user with at least partially separating the two substrates to expose information printed in the thermosensitive imaging layer.

### BRIEF DESCRIPTION OF THE DRAWING FIGURES

FIG. 1 is a front view of a direct thermal printable construct in accordance with the invention.

FIG. 2 is a cross-sectional side view of the thermal printable construct along line 2-2 of FIG. 1.

FIG. 3 is a front view of a base substrate of the thermal printable construct showing a serpentine line of perforation through the base substrate and a patterned release layer applied over a portion of a thermosensitive imaging layer on a front face of the base substrate.

FIG. 4 is a similar front view incorporating the features shown in FIG. 3 and adding striped patterns of a clean-release binder layer.

FIG. 5 is an image of such a construct with a metallized film cover substrate peeled back to show thermal printing within the thermosensitive imaging layer.

FIGS. 6A-6C are front views of another direct thermal printable construct in the form of a “scratch-off” ticket with “scratch-off” film segments covering thermally printed contents in progressive states of removal.

FIG. 7 is a cross-sectional view of the “scratch off” ticket of FIGS. 6A-6C taken along line 7-7 of FIG. 6A.

FIG. 8 schematically depicts a printing press especially suited for printing such “scratch-off” tickets.

FIG. 9 depicts an interactive gaming system particularly suited for use with the “scratch-off” tickets.

FIGS. 10A-10C depict examples of individual island die cut patterns from a single strike or other cutting means.

FIGS. 11A-10D depict examples of individual island die cut patterns from two or more different strikes or other cutting means.

FIG. 12 is a front view of a truncated “scratch-off” ticket with oval-shaped islands that have been fractured in a plurality of different patterns.

FIGS. 13A-13C depict one of the individual fractured islands with die cut segments progressively removed to expose underlying printed information.

FIG. 14 depicts a die cut pattern that is embossed or thermally printed on a thermally printable medium base substrate in registration with a thermally printed image by the combination of thermal printing and a die strike through one of the fractured islands that is subsequently removed.

FIG. 15 depicts a fractured island in which the pattern produced by one or more die strikes is arranged as a confusion pattern to further thwart viewing of underlying printed information.

FIG. 16 depicts another example of a fractured island in which the fractured island includes a die-cut outer segment in the form of a protective ring and inner segments formed in a crisscross pattern and at a reduced size.

FIGS. 17A-17B present front and back views of a double-sided direct thermal printable construct in the form of a “scratch-off” ticket with fractured islands, a removable coupon, and other features.

FIG. 18 is a cross-sectional side view of the double-sided direct thermal printable construct taken along line 18-18 as shown in both FIGS. 17A and 17B.

FIG. 19 is an enlarged front view of an island overprinted with both a confusion pattern and graphics.

### DETAILED DESCRIPTION

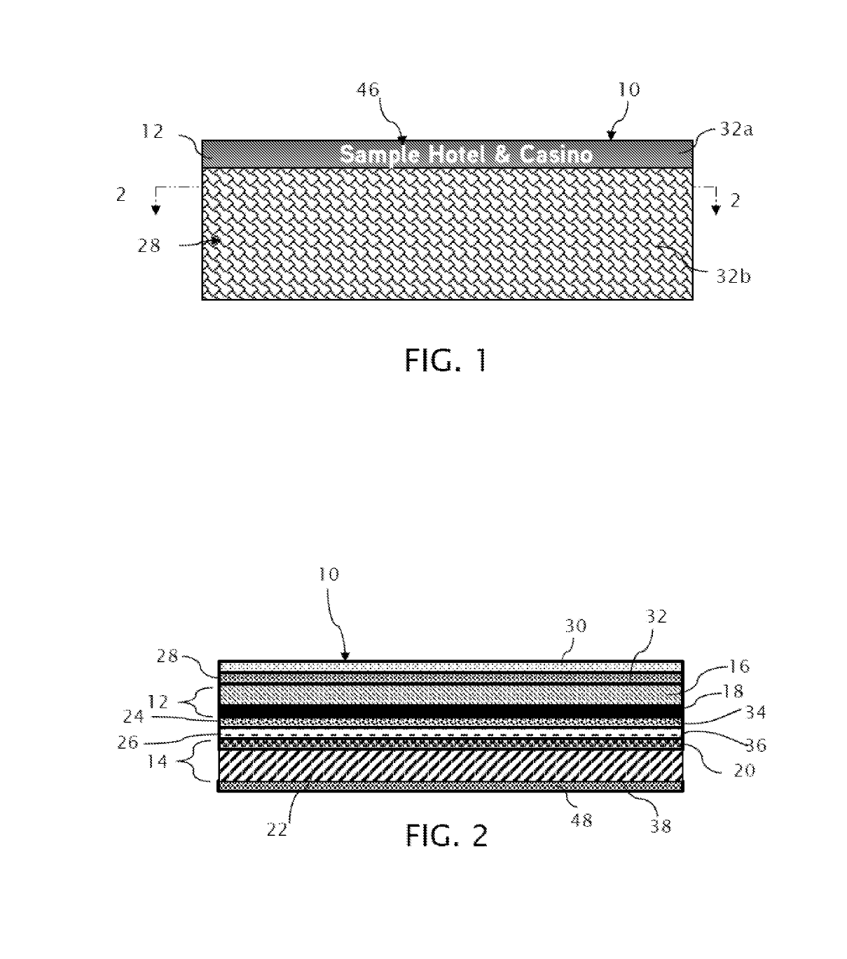

FIGS. 1 through 5 depict various views of a direct thermal printable construct 10 or its component parts. The direct thermal printable construct 10 takes the form of a ticket or game piece that is thermally printable with both immediately visible and temporarily hidden information. With particular reference to FIG. 2, the construct 10 includes a cover substrate 12 in the form of a metallized film and a base substrate 14 in the form of a thermally printable medium. Although reference is made to top and bottom or front and back surfaces, layers or other features to distinguish their relative positions or orientations in the drawings, the relative positions and orientations of these features can be collectively inverted or reversed during actual use.

As depicted, the metallized film cover substrate 12 includes a clear film 16 and a metallized layer 18 deposited onto the clear film 16 rendering the cover substrate 12 substantially opaque. The thermally printable medium base substrate 14 includes a thermosensitive imaging layer 20 atop a paper or film backing 22 and can be of a type that is commercially available or can be formed by coating the thermosensitive imaging layer 20 on a choice of backings 22. The thermosensitive imaging layer can be arranged to support single or multiple thermally induced color changes. Multiple color changes in the thermosensitive imaging layer can be effected between different areas of the base substrate or within the same area of the base substrate such as by incorporating different temperature-sensitive dyes and regulating printing temperatures accordingly. Preferably, the thermally printable medium base substrate 14 is substantially opaque as a result of its composition alone or in combination with an additional coating or printing. For example, a direct thermal security stock, such as SecuraTherm® printing stock from Appvion, Inc. of Appleton, Wis. with a color centered security feature, can be used for verification and fraud protection as well as to increase opacity.

The metallized film cover substrate 12 is releasably bonded to the thermally printable medium base substrate 14 by a clean-release adhesive, which can be formed by the combination of a cold glue layer 24 and a release layer 26. Both the cold glue layer 24 and release layer 26 can be pattern coated onto one or both substrates 12 and 14. One of the two layers 24 and 26, preferably the cold glue layer 24, is preferably coated just prior to laminating the two substrates 12 and 14 together.

By way of example, the cold glue layer 24 can comprise a dry peel; fast drying, vinyl acetate/acrylic such as supplied by D&B Technologies as 201 Cold Glue. The release layer 26 can comprise a solvent based PCF Release product from Flint Group having a composition of n-Propanol (Propyl-Alcohol; Ethylcarbinol) of 40-70%, Zinc Stearate of 5-10%, Zinc of 1-5%, and 1-Methoxy-2-Hydroxypropane of 0.1-1%. The release layer 26 is preferably applied first to the front surface 36 of the thermally printable medium base substrate 14 and air dried. The cold glue layer 24, which is preferably diluted in water to the lowest effective coat weight, is preferably applied atop the release layer 26. The metallized film cover substrate 12 is preferably laminated to the thermally printable medium base substrate 14 while the cold glue layer 24 is still wet. The remaining water in the cold glue layer 24 can be evaporated from the laminate through forced heat drying.

The compound and solvent components of the release layer 26 repel the water-based glue and form a protective barrier to prevent migration of the water-based glue into the thermosensitive imaging layer 20 of the thermally printable medium base substrate 14. Thus, the release layer 26 both provides a protective barrier for the thermally printable medium base substrate 14 and cooperates with the dried cold glue layer 24 to form a clean release adhesive. The water-based glue, although of sufficient weight to form, together with the release material, a clean-release adhesive of sufficient strength to maintain a bond between the metallized film cover substrate 12 and the thermally printable medium base substrate 14 during both normal handling and thermal printing, is preferably diluted to support sufficient thermal conductivity between the cover and base substrates 12 and 14 so that images can be formed in the thermosensitive imaging layer 20 by thermally printing through the metallized film cover substrate 12 at customary heat and pressure settings of a thermal printhead. Dry residue from the cold glue layer 24, although minimal, preferably remains primarily on the back surface 34 of the metallized film cover substrate 12 upon peeling or otherwise separating the metallized film cover substrate 12 from the thermally printable medium base substrate 14. The release layer 26, however, remains with the thermally printable medium base substrate 14 maintaining a clear protective coating over the thermosensitive imaging layer 20.

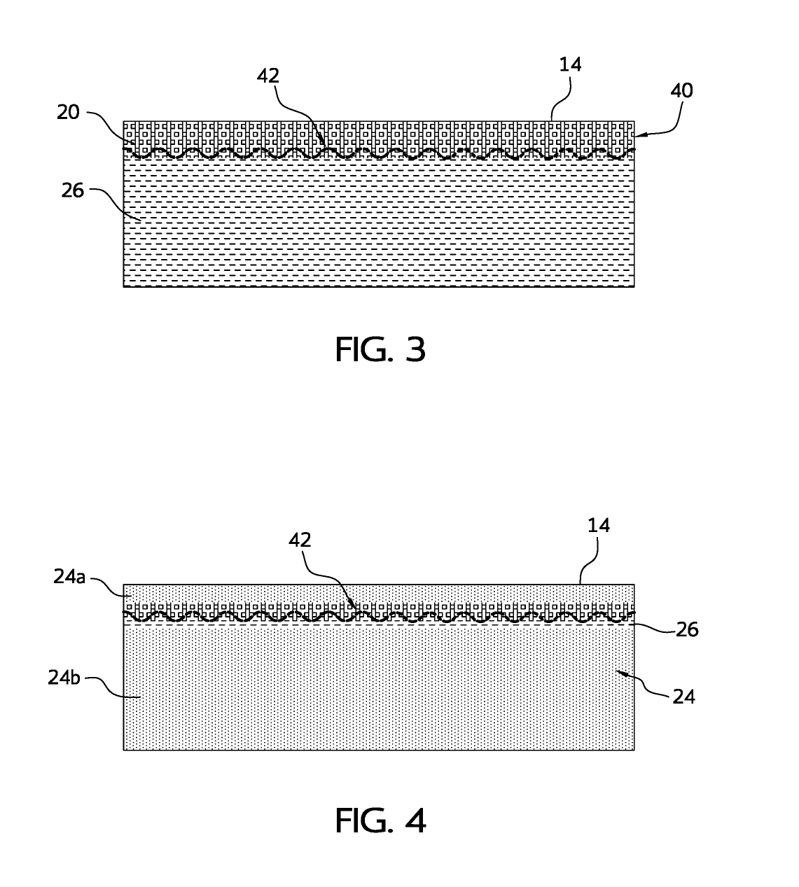

As shown in FIG. 3, the release layer 26 is coated over the thermosensitive imaging layer 20 on the front surface 36 of the substrate 14 in a pattern that omits coating along a top edge portion 40 of the base substrate 14, leaving a portion of the thermosensitive imaging layer 20 exposed on the front surface 36 of the base substrate 14. Within the top edge portion 40, a serpentine line of perforation 42 is formed through the base substrate 14.

As shown in FIG. 4, the cold glue layer 24 is pattern coated in two places. A first narrow stripe 24a of the cold glue layer 24 is applied directly to the thermosensitive imaging layer 20 within the top edge portion 40 apart from the serpentine line of perforation 42. A second wider stripe 24b of the cold glue layer 24 is applied over the release layer 26, leaving a small portion of the release layer 26 exposed between the second stripe 24b and the serpentine line of perforation 42. The first stripe 24a provides a stronger and more direct bond between the metallized film cover substrate 12 and the top edge portion 40 of the thermally printable medium base substrate 14, thereby forming a tab that is separable along the serpentine line of perforation 42 for peeling back the metallized film cover substrate 12 from the remainder of the thermally printable medium base substrate 14.

As shown in the front view of FIG. 1, a first confusion pattern 28 is printed over a substantial portion 32b of a front surface 32 of the metallized film cover substrate 12. However, an exposed portion 32a of the front surface 32 is not covered by the first confusion pattern 28. A varnish layer 30 containing matting agents covers the entire front surface 32 over top of the first confusion pattern 28 to provide a smooth surface for engaging a thermal printhead. A second confusion pattern 48 can be printed on a back surface 38 of the base substrate 14 to further obscure images printed in the thermosensitive layer 20.

The assembled construct 10 is intended for on-demand printing by a thermal printer. The metallized film cover substrate 12, together with the confusion pattern and varnish layers 28 and 30 on the front surface 32 of the cover substrate 12 and the cold glue and release layers 24 and 26 of the clean-release adhesive between on the back surface 34 of the cover substrate 12 and the front surface 36 of the base substrate 14, is arranged to be thermally transmissive, and the thermal printhead applies localized heat and pressure to the front surface 32 to induce a thermal response in the underlying thermosensitive imaging layer 20 resulting in the formation of a printed image matching the applied pattern of thermal energy. The printed image in the thermosensitive layer remains hidden behind the metallized film cover substrate 12 until the cover substrate is peeled back.

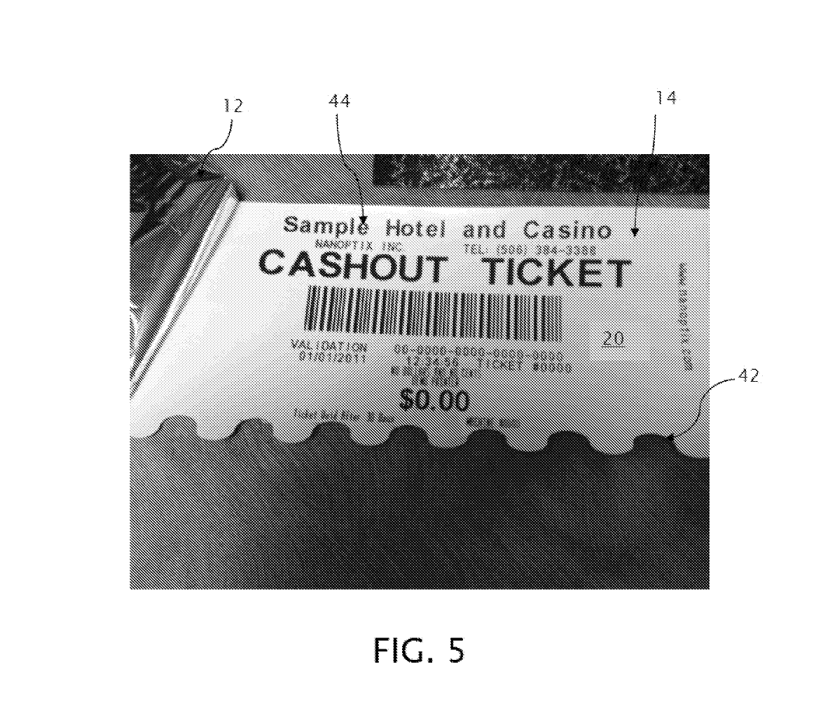

FIG. 5 shows an example of a printed image 44 formed in the thermosensitive imaging layer 20 with the metallized film cover substrate 12 peeled back assisted by the top edge portion 40 of the thermally printable medium base substrate 14, which forms a tab that is separated along the serpentine line of perforation 42. Although the construct of FIG. 5 is inverted with respect to FIGS. 3 and 4, the view demonstrates that the various patterns that form the tab structure can be exchanged top to bottom or left to right as a matter of preference.

Returning to FIG. 1, in addition to producing thermally induced printed image 44 shown in FIG. 5, the same thermal printing operation can be used to produce a thermally induced printed image 46 in the exposed portion 32a of the front surface 32 that is not covered by the confusion pattern 28 via a phenomenon referred to as “branding.” Although both printed images 44 and 46 can be induced by comparable amounts of localized heat and pressure applied by the thermal printhead to the front surface 32 of the metallized film cover substrate 12, the printed image 46 is formed by different mechanism than the printed image 44. Instead of inducing a color change in a thermosensitive medium, the heat and pressure applied to the clear film 16 supporting the underlying metallized layer 18 locally change the reflectivity characteristics of the metallized film cover substrate 12. Untreated, the metallized film cover substrate 12 is substantially specularly reflective. The referenced thermal printing, however, renders the locally affected portions exposed to the heat and pressure of the printhead substantially more diffuse. Accordingly, light is reflected differently, i.e., more diffusely, from the locally affected portions with respect to the light that is reflected from the remaining exposed portion 32a of the metallized film cover substrate 12, producing the necessary contrast for rendering the printed image 46 visible. The printed image 46 can appear lighter or darker than the remainder of the exposed portion 32a depending on the position of an observer with respect to a light source illuminating the front surface 32 of the metallized film cover substrate 12.

The first confusion pattern 28, which is printed over the exposed portion 32a of the front surface 32 of the metallized film cover substrate 12, is preferably printed with multiple inks or varnishes that exhibit different reflective characteristics within a range that varies optically from specular to diffuse and expressed in the ink or varnish within a range from high gloss through semi-gloss, satin, and eggshell to flat. Preferably, one of the inks or varnishes is a high gloss or semi-gloss mimicking the more specular reflective properties of the metallized film cover substrate 12 that has not been subject to thermal printing and another of the inks or varnishes is a satin or eggshell mimicking the more diffuse reflective properties of the areas of the metallized film cover substrate 12 that have been subject to thermal printing. In addition, the two or more inks or varnishes exhibiting different reflective properties can be of the same color including no color at all. For example the printed inks of the confusion pattern 28 can be printed with an ink having a color of white to gray for further limiting contrast with a metallized film containing a layer of aluminum. The two or more inks or varnishes that exhibit differing reflectivity characteristics can be printed in complementary patterns occupying pluralities of juxtaposed regions or can be printed one over the other in different patterns.

The second confusion pattern 48, which is printed on the back surface 38 of the thermally printable medium 14, is preferably printed with an ink designed to further obscure the printed image 44 formed in the thermosensitive imaging layer 20, particularly as a countermeasure to thwart “candling,” i.e., shining a high intensity light through the construct 10 towards a viewer for revealing contrasts within the thermosensitive imaging layer 20. The color and pattern of the ink is selected to mimic the type of contrast between the printed image 44 and the remainder of the thermosensitive imaging layer as may be apparent through the construct 10. As such, lines and shapes, and in particular characters, of the printed image 44 become largely indistinguishable from the lines and shapes of the second confusion pattern 48 during “candling.” Although not shown, one or more additional layers of ink can be applied over the second confusion pattern 48 to cover the second confusion pattern 48 and provide for displaying additional text or graphics.

According to another example of the first confusion pattern 28, a matte gray ink is printed in a pattern composed of small boxes of differing tint levels distributed in a random appearing manner throughout an array, including boxes of 0%, 25%, 50%, 75%, and 100% tints; along with scattered barcodes, characters, including numbers (e.g., 0's), and symbols (e.g., “$”) printed with a 100% gray tint. Here, tint is considered in terms of the percent contribution of the printed ink to the color appearing in the box, which would otherwise be the color of the metallized film cover substrate. In addition, a gloss black ink also composed of barcodes, letters, numbers and symbols at varying font sizes is printed over the printed matte gray ink pattern. The barcodes, letters, numbers and symbols at varying font sizes are intended to mimic the expected types and orientation of the print elements likely to be thermally printed on and within the construct 10. The matte and gloss elements of the printed confusion pattern cooperate with the inherent reflective properties of the metallized film cover substrate 12 along with varying font sizes create the appearance of depth within the print. Ink density affecting tint levels can also be adjusted for printing the second confusion pattern 48 to better match the confusion pattern to the appearance of the thermally printed information through the base substrate.

### Direct Thermal Construct with “Scratch-Off” Islands

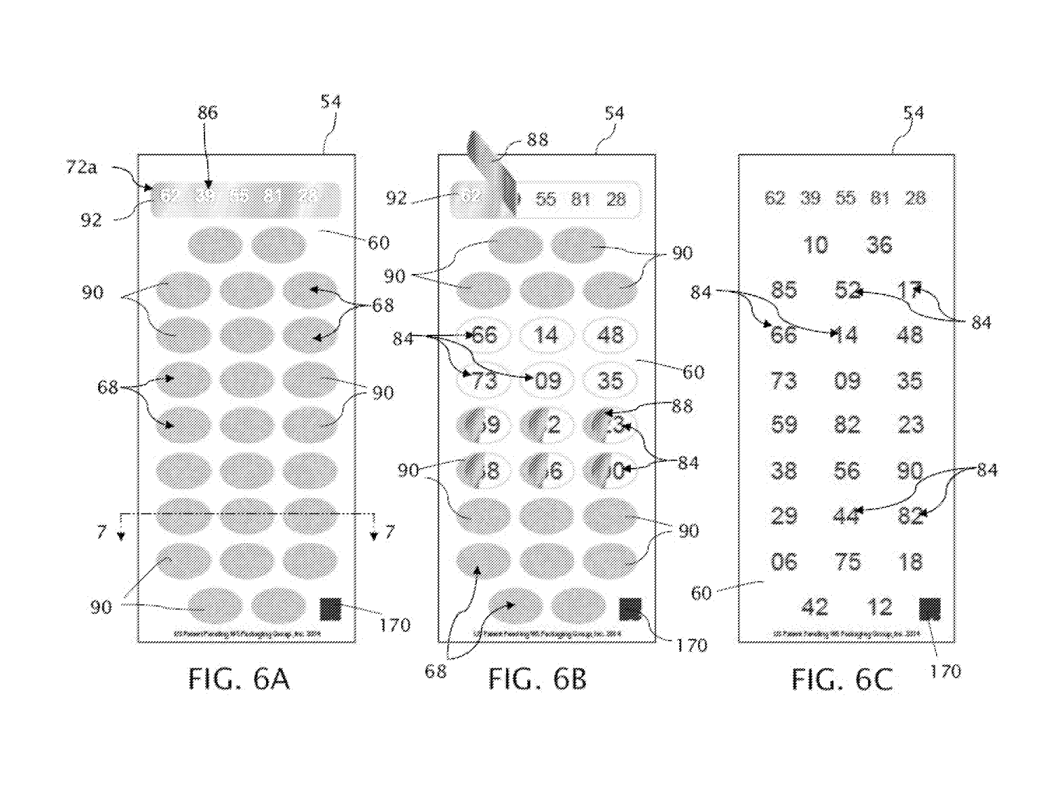

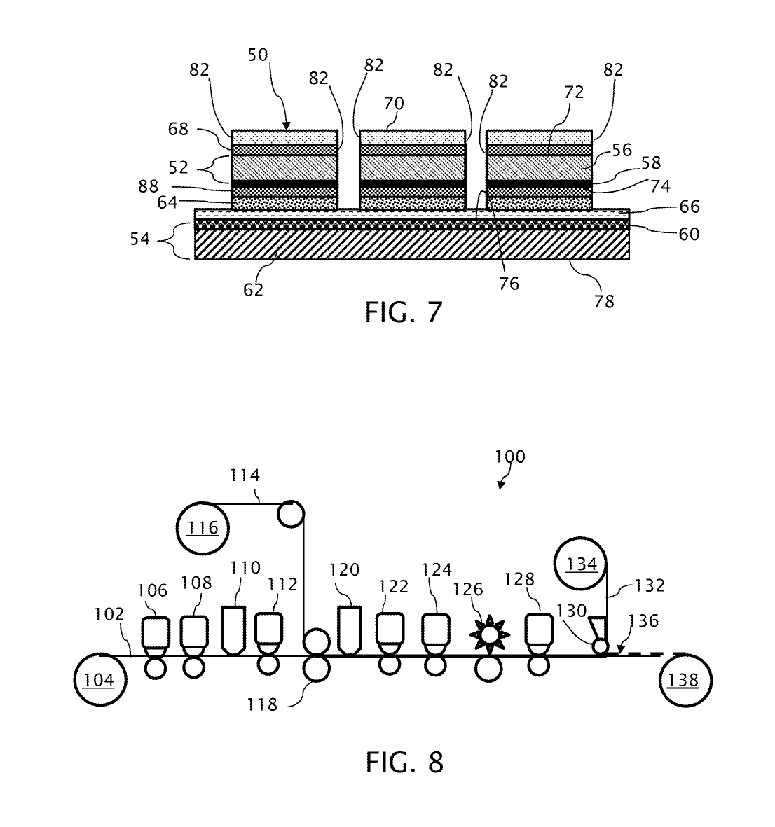

FIGS. 6A through 6C and 7 depict another example of a direct thermal printable construct 50 also in the form of a ticket or other game piece. As shown in the cross-sectional view of FIG. 7, the construct 50 includes layers similar to the construct 10 but has been die cut through a cover substrate 52 also in the form of a metallized film to form the equivalent of a “scratch-off” type ticket. Defined areas of the metallized film cover substrate 52 shaped as ovals and referred to as “islands” 90 remain mounted on an uninterrupted thermally printable medium base substrate after a matrix die cut through the metallized film cover substrate 52 has been separated and removed from the thermally printable medium base substrate 54. The islands 90 are individually removable from the base substrate 54 by a scraping, peeling, or scratching action, such as by using a fingernail, coin, or other tool, and thereby form so-called “scratch-off” islands for temporarily hiding images in the underlying thermal printable medium base substrate 54, which are thermally printed through the islands 90. Although the islands 90 are shown in the shape of ovals and arranged in a rectangular array, the islands 90 can be individually shaped and positioned on the base substrate 54 as desired. For example, the islands 90 can be alternatively shaped as other geometric forms such as circles, triangles, rectangles, diamonds, trapezoids, and polygons and other familiar shapes such as stars, hearts, crescents, eggs, and clouds, as well as more fanciful or irregular shapes that might be associated with the intentions for printing the construct 50 or the islands 90 themselves including faces, cars, and other objects or symbols. Shapes of the islands 90 can be the same or different within a single ticket construct and can be distributed in regular or irregular patterns in accordance with the requirements for hiding underlying information for presenting “scratch-off” options to users. The islands 90 are shown relatively displaced from one another but islands of complementary shapes could be clustered together like the pieces of a puzzle separated only by die cuts. Although the islands 90 are referred to as having been die cut through the cover substrate 52, other cutting mechanisms can be used to similar effect such as laser cutting or etching.

The metallized film cover substrate 52 includes a clear film 56 and a metallized layer 58 rendering the cover substrate 52 substantially opaque. The thermally printable medium base substrate 54 includes a thermosensitive imaging layer 60 atop a paper or film backing 62, which is preferably substantially opaque as a result of its composition alone or in combination with an additional coating or printing. The thermally printable medium base substrate 54 can be of a type that is commercially available or can be formed by coating the thermosensitive imaging layer 60 on a choice of backings 62. The thermosensitive imaging layer 60 can be arranged to support single or multiple color changes as a function of temperature or position on the base substrate 54.

The metallized film cover substrate 52 is releasably bonded to the thermally printable medium base substrate 54 by a clean-release adhesive, which can be formed by the combination of a cold glue layer 64 and a release layer 66. Both the cold glue layer 64 and the release layer 66 are preferably coated onto one or both substrates 52 and 54. However, one of the two layers 64 and 66, preferably the cold glue layer 64, is preferably coated just prior to laminating the two substrates 52 and 54 together. The coatings can be applied in a variety of ways on press such as by printing plates or tint sleeves including by way of flood coating or pattern printing.

For example, the release layer 66 can be coated over the thermosensitive imaging layer 60 on the front surface 76 of the substrate 54, and the cold glue layer 64 can be coated over the release layer 66. Preferably, the cover and base substrates 52 and 54 are laminated together before the cold glue layer 64 dries. Alternatively, the cold glue layer 64 can be coated on a back surface 74 of the metallized film cover substrate 52 and immediately laminated together with the release layer 66 to form the desired clean-release adhesive layer releasably bonding the cover and base substrates 52 and 54 together.

A first confusion pattern 68 is printed on the front surface 72 over a substantial portion of the cover substrate 52 excluding an exposed portion 72a, which is at least partially occupied by an island 92 as shown in FIGS. 6A and 6B shaped as a rectangular strip. A varnish layer 70 containing matting agents covers the entire front surface 72 over top of the first confusion pattern 68 to provide a smooth surface for engaging a thermal printhead. A second confusion pattern 88 is printed on the back surface 74 of the metallized film cover substrate 52.

Die cuts 82 extend through the metallized film cover substrate 52 without substantially penetrating the thermally printable medium base substrate 54 forming a matrix that can be removed for presenting the metallized film cover substrate as a plurality of islands 90 and 92 releasably mounted on the uninterrupted thermally printable medium base substrate 54. The islands 90 and 92 are similarly exposable to a thermal printhead for on-demand printing by a thermal printer. The metallized film cover substrate 52, together with the confusion pattern and varnish layers 68 and 70 on the front surface 72 of the cover substrate 52, the cold glue and release layers 64 and 66 of the clean-release adhesive, and the second confusion pattern 88 between on the back surface 74 of the cover substrate 52 and the front surface 76 of the base substrate 54, is arranged to be thermally transmissive, and the thermal printhead applies localized heat and pressure to the front surface 72 to induce a thermal response in the underlying thermosensitive imaging layer 60 resulting in the formation of printed images 84 matching the applied pattern of thermal energy. The printed images 84 in the thermosensitive imaging layer 60 remain hidden behind the islands 90 of the metallized film cover substrate 12 as shown in FIG. 6A until the islands 90 are peeled apart as shown in FIG. 6B. Preferably, the slightly raised islands 90 are peelable apart from the thermally printable medium base substrate 54 by a scraping or scratching action for having the effect of providing scratch-off coverings for the underlying printed images 84.

Referring particularly to FIG. 6A, in addition to producing thermally induced printed images 84 as shown in FIGS. 6B and 6C, the same thermal printing operation can be used to produce thermally induced printed images 86 in the exposed portion 72a of the front surface 72 that is not covered by the confusion pattern 68 via the phenomenon referred to as “branding.” Although both sets of printed images 84 and 86 are induced by comparable amounts of localized heat and pressure applied by the thermal printhead to the top surface 72 of the metallized film cover substrate 52, the printed images 86 are formed by different mechanism than the printed images 84. Instead of inducing a color change in a thermosensitive medium, the heat and pressure applied to the clear film 56 supporting the underlying metallized layer 58 locally change the reflectivity characteristics of the metallized film cover substrate 52. Untreated, the metallized film cover substrate 52 is substantially specularly reflective. The referenced thermal printing, however, renders the locally affected portions exposed to the heat and pressure of the printhead substantially more diffuse. Accordingly, light is reflected differently, i.e., more diffusely, from the locally affected portions with respect to the light that is reflected from the remaining exposed portion 72a of the metallized film cover substrate 12, producing the necessary contrast for rendering the printed imaged 86 visible. The printed images 86 can appear lighter or darker than the remainder of the exposed portion 72a depending on the position of an observer with respect to a light source illuminating the front surface 72 of the metallized film cover substrate 52.

Similar to the confusion pattern 28 of the construct 10, the confusion pattern 68, which is printed over the portion of the front surface 72 of the metallized film cover substrate 52 occupied by the islands 90, is preferably printed with multiple inks or varnishes that exhibit different reflective characteristics within a range that varies optically from specular to diffuse and expressed in the ink or varnish within a range from high gloss through semi-gloss, satin, and eggshell to flat. Preferably, one of the inks or varnishes is a high gloss or semi-gloss mimicking the more specular reflective properties of the metallized film cover substrate 52 that has not been subject to thermal printing and another of the inks or varnishes is a satin or eggshell mimicking the more diffuse reflective properties of the areas of the metallized film cover substrate 52 that have been subject to thermal printing. In addition, the two or more inks or varnishes exhibiting different reflective properties can be of the same color including no color at all. For example the printed inks of the confusion pattern can be printed with an ink having a color of white to gray for further limiting contrast with a metallized film containing a layer of aluminum. The two or more inks or varnishes that exhibit differing reflectivity characteristics can be printed in complementary patterns occupying pluralities of juxtaposed regions or can be printed one over the other in different patterns.

The second confusion pattern 88, which is printed on the back surface 74 of metallized film cover substrate 52, is preferably printed with an ink designed to further obscure the printed images 84 formed in the thermosensitive imaging layer 60, particularly as a countermeasure to thwart “candling.” The color and pattern of the ink is selected to mimic the type of contrast between the printed images 84 and the remainder of the thermosensitive imaging layer 60 as may be apparent through the construct 50. As such, lines and shapes, and in particular characters, of the printed images 84 become largely indistinguishable from the lines and shapes of the second confusion pattern 88 during “candling.” Alternatively, similar to the construct 10, the second confusion pattern 88 can be printed on the back surface 78 of the thermally printable medium base substrate 54. If either the metallized film cover substrate 52 or the thermally printable medium base substrate 54 is sufficiently substantially opaque to light being shined through the construct 50, the second confusion pattern 88 may be unnecessary to prevent “candling.”

For the dual purpose of obscuring the branding effects of a thermal printer and inhibiting candling for observing contrasts in the printed thermosensitive imaging layer 20 or 60, (a) the reflectivity of the two inks of the first confusion pattern 48 or 88 can be relatively varied to obscure reflectivity contrasts in the front surfaces 32 or 72 of the metallized film cover substrate 12 or 52 and (b) at least one color among the two or more inks of the first confusion pattern 48 or 88 can be matched to the appearance of the dye released in the printed thermosensitive imaging layer 20 or 60 to obscure the corresponding color change in the printed thermosensitive imaging layer 20 or 60. A confusion pattern 48 or 88 can also be printed in multiple overlapping or spatially differentiated colors corresponding to multiple color changes in the printed thermosensitive imaging layer 20 or 60 over the same or different areas.

### Press Manufacture

Constructs in accordance with the embodiments described herein, including the ticket constructs 10 and 50, are preferably made on a printing press, such as the press 100 depicted by FIG. 8. A first web 102 comprising a thermally printable medium, such as the mediums 14 and 54, enters the press 100 via an unwinder 104. The thermally printable medium of the first web 102 preferably includes a thermosensitive imaging material for forming thermosensitive imaging layer 20 or 60 coated onto a paper or film backing. The first web 102 is advanced through a first printing station 106, which can print registration marks and other information in the form of test or graphics, and a first coating station 108 for applying a release material coating, such as the release layer 26 or 66. An air dryer station 110 dries the release coating. UV curing or other curing or drying techniques could be used if necessary. Alternatively, the first web 102 could be pre-coated with a release material. A cold glue applicator station 112 applies cold glue, preferably in a water-diluted form, such as the cold glue layer 24 or 64, over top of the release material coating. The applicator stations 108 and 112 can be arranged for either flood coating or pattern coating of the first web 102 in accordance with the requirements of the desired constructs such as the constructs 10 and 50.

A second web 114 comprising a metallized film, such as the metallized film 12 or 52 enters the press 100 via an unwinder 116. Before the cold glue layer has completely dried, the second web 114 of metallized film is laminated to the first web 102 of thermally printable medium at a laminating station 118. Thereafter, the cold glue layer is dried at drying station 120 to remove excess water. Other curing or drying techniques can be used depending on the nature of the glue used to laminate the two webs 102 and 114 together.

Printing stations 122 and 124 apply patterns of ink or varnish with different reflective properties to the metallized film to form a confusion pattern, such as the confusion patterns 28 and 68. Preferably, the confusion pattern is pattern coated so that one portion of the metallized film (composed of a one or more stripes or multiple sections) is covered by the confusion pattern, such as the substantial portions 32b and 72b, and another portion of the metallized film (composed of a one or more stripes or multiple sections) is not covered by the confusion pattern, such as the exposed portions 32a and 72a.

A die cutting station 126 or other cutting mechanism, including a laser cutter, preferably cuts through one or the other but not both of the webs 102 and 114 to support the subsequent separation of local portions of the completed webs. For example, a serpentine line of perforation 42 can be cut in the thermally printable medium first web 102 for forming a tab feature of the construct 10, and die cuts 82 extend through the metallized film second web 114 to define “scratch-off” islands 90 and 92 within a removable matrix. The same or additional cutting stations can be used to fracture the islands 90 as described in further embodiments below. Another applicator station 128 applies a matted varnish coating, such as the varnish layers 30 or 70, over both the portions of the metallized film that are printed with the confusion pattern and the portions of the metallized film that are not printed with the confusion pattern.

A stripping station 130, if necessary, separates a waste matrix 132, which is subsequently collected by a waste rewinder 134. The remaining laminate 136, which includes an array of constructs, such as the construct 50, is collected by a main rewinder 138. Multiple ticket constructs can be formed across the widths of the webs 102 and 114 and the remaining laminate 136 can be slit between the ticket constructs into separate rolls for rewinding. Alternatively, the ticket constructs can be separated by die cut lines of perforation and rolled or fan-folded for distribution. The varnish coating can be applied before or after the web 114 is die cut (or otherwise cut), including between die cutting stages, as well as before or after the waste matrix 132 is stripped. The application of the varnish layer following the formation of fracture patterns in the islands can be used to present more uniform surfaces for direct thermal printing.

Additional printing stations can be arranged for printing on one or more surfaces of the webs, including printing the second confusion patterns 48 and 88 on the bottom surfaces of the webs 102 and 114 before or during operations on the press 100. Conventional (non-direct-thermal) printing can also be applied to any of the web surfaces to provide constructs of particular uses, preprinted with logos, graphics, instructions, or other information. Such decorative or informational printing can be pre-applied, applied on press, or applied thereafter to any of the surfaces of the constructs 10 or 50 that may be subject to viewing before or after the cover and base substrates 12, 52 and 14, 54 are separated. In addition, logos, codes, or other indicia can be printed on the exposed faces of the webs such as for aiding desired registration of the die cuts 82 or subsequent on-demand printing, distinguishing different constructs or uses for the constructs (such as different games), uniquely identifying individual constructs, and for enhancing the appearance or intended function of the islands 90 and 92.

Although the islands 90 depicted in the FIGS. 6A-6C are arranged to be individually removable, similarly constructed islands could be interconnected so that the islands are disposable as a group. For example, the islands could be interconnected by narrow ties formed in the metallized film cover substrate. In addition, all or a portion of the matrix from which the islands are die cut could remain attached to the thermally printable base substrate in a temporary or more permanently bonded condition. Die cut patterns could be arranged to leave connections between the remaining matrix and the individual islands so that the islands could be substantially separated (e.g., peeled apart) from the thermally printable base substrate but remain attached to the remaining matrix. If the remaining matrix were to be removable, the islands, upon being individually peeled from the thermally printable base substrate could be removed together with the remaining matrix from any further connection to the thermally printable base substrate. By patterning adhesive or release layers, the remaining matrix or portions of the individual islands could be more permanently bonded to the thermally printable base substrate so that while the islands would remain peelable apart from the thermally printable base substrate to reveal the desired underlying thermally printed information, the islands would remain attached to the thermally printable base substrate.

### Gaming System

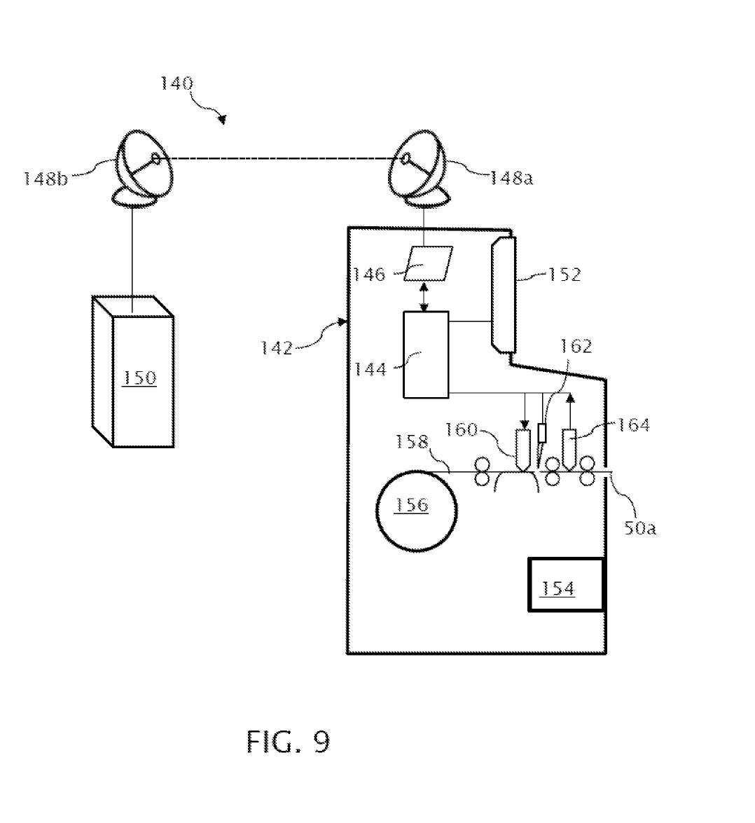

The construct 50 is particularly suited for use in an interactive gaming system, such as the gaming system 140 depicted in FIG. 9. A player can interact with a gaming terminal 142, making selections as to the game to be played, the stakes to be applied, and the values of variables to be submitted for play. While the terminal can include its own processor 144, an I/O interface 146 in conjunction with a secure communication link depicted as a pair of parabolic antenna 148a and 148b, preferably connects the terminal 142 to a central processing system 150, which operates one or more gaming algorithms associated the games playable from the terminal 142.

A graphical user interface 152 of the terminal 142 depicted in the form of a touch screen displays available options to the player and accepts player inputs. The player inputs choices among one or more games that can be played and chooses the stakes (where available), such as the number of tries at a particular game or the amount of money or other game currency to be put at risk for each try. In addition, the player can choose the values of the variables to be played, such as choosing a set of five two-digit numbers, each from a given range of digits from “01” to “99.” A separate intake mechanism 154 can be used to collect the amount selected to be wagered, including the cost of a ticket for a particular game, in a form such as cash, voucher, or other transaction vehicle.

The central processing system 150, which can be connected to other similar terminals, receives the input selections of the player, executes the gaming algorithm corresponding to the game selected by the player, and produces an intermediate result, which when compared to the player's chosen values of the variables subject to play determines an outcome of the game. For example, the intermediate result can contain a set of two-digit numbers arranged in an ordered array and subject to comparison with the player-selected set of two-digit numbers according to the rules of the game. A unique confirmation code can be generated and linked to a file or other record that can contain the player's chosen values, the stakes applied, the intermediate values, the outcome, and any award due to the player, as well as environmental information concerning the originating terminal 142 and the date and time of associated events such as the transmissions to and from the central processing system, the operation of the algorithm, and the assignment of the confirmation code.

Over preferably the same secure communication link 148a and 148b, the central processing system 150 sends the intermediate results, such as the ordered array of two-digit numbers, any required formatting information, and the confirmation code to the terminal 142. Within the terminal 142, the information generated by the central processing system 150, together with the player selections input at the terminal 142, is formatted or otherwise readied for printing. An on-demand print system including a roll 156 of “scratch-off” on-demand print media 158, preferably arranged as a succession of the ticket constructs 50, feeds a thermal printer 160 for printing the formatted information in at least approximate registration with intended positions on the ticket constructs 50. A registration mark preprinted on the ticket construct 50 readied for printing can be used to register the formatted information intended for printing.

The player's chosen values can be printed in a form that is visible on the face of the ticket construct 50, e.g., as the thermally induced printed images 86 on the exposed portion 72a of the metallized film cover substrate 52, and the intermediate results generated by the central processing system 150 can be printed on an internal layer of the ticket construct 50 in a form that is initially hidden from similar viewing, e.g., as the thermally induced printed images 84 in the thermosensitive imaging layer 60 of the thermally printable medium base substrate 54. For example, the player's chosen values can be printed on and through the defined island area 92. Local variations in reflectivity of the exposed portion of the metallized film cover substrate 52 generated by the thermal printing on the defined island area 92 render the player selections 86 visible on the face of the construct 50. Alternatively, the player chosen values can be printed directly on an exposed portion of the thermally printable medium base substrate 54. The heat induced color transformations in the thermosensitive imaging layer 60 generated by the thermal printing through the defined islands 90 record the intermediate results 84 in a fashion that is hidden between the islands 90 of the cover substrate 52 and base substrate 54. The confusion pattern 68 printed over the islands 90 obscures the reflectivity altering effects of the thermal printing through the islands 90 of the metallized film cover substrate 52. In addition, the confirmation code generated by the central processing system 150 can be preferably printed directly on an exposed portion of the thermally printable medium base substrate 54 where the metallized film matrix 132 (see FIG. 8) has been removed, e.g., as a two-dimensional barcode 170 depicted in FIGS. 6A-6C. Alternatively, the confirmation code, such as the code 170, could be printed through either an exposed island 92 for immediate viewing or through a confusion pattern covered island 90 to remain temporarily hidden.

After thermal printing, the on-demand print media 158 can be advanced through a cutter 162 that least partially cuts through the print media 158 between individual ticket constructs 50. Alternatively, a succession of the ticket constructs could be separated by lines of perforation and mechanically separated such as at a breaker bar. An at least partially separated lead ticket construct 50a can be advanced for dispensing from the terminal 142. Preferably, prior to dispensing, the lead ticket construct 50a is read by an optical reader 164 to confirm that a ticket construct 50a with the assigned confirmation code, such as the code 170, has been printed by the originating terminal 142. This information can also be collected and recorded by the central processing system 150 to qualify the printed ticket construct 50a for redemption.

The player receives the printed ticket construct 50a for further play. As initially received by the player, the player can recognize that the ticket construct 50a displays player's chosen values, e.g., printed images 86, but the outcome of the game remains indeterminate from the face of the ticket construct 50a. However, the player can remove the islands 90 by peeling the islands 90 apart from the thermally printable medium base substrate 54 as shown in FIG. 6B. A scraping or scratching motion engaging a periphery of the islands 90 can be used to peel the pliant islands 90 from the more substantial base substrate 54. The clean-release adhesive applied between the cover and base substrates 52 and 54 preferably leaves no tacky residue on either the islands 90 of the cover substrate 52 or the underlying base substrate 54 when the islands 90 are removed.

The successive removal of the islands 90 progressively reveals the intermediate results as the printed images 84 in the thermosensitive imaging layer 60. Once the intermediate results are so revealed, the player can assess the outcome of the game and the extent of any winnings according to the rules of the game. The island 92 can be similarly removed to facilitate the comparison between the player's chosen values and the intermediate results—both as similarly formed images in the thermosensitive imaging layer 60 as shown in FIG. 6C. If the ticket construct 50a is suspected of being a “winner,” the ticket construct 50a can be submitted for redemption at the terminal 142 or at another terminal capable of reading the confirmation code, such as the code 170, and submitting this information along with any other desired information that might be read from the ticket construct or associated with the transmission of the information to the central processing system 150. If confirmation code transmitted to the central processing system 150 for redemption properly matches a recorded confirmation code, and the additional transmitted information is otherwise in conformity with the information stored with the confirmation code or elsewhere, the central processing system approves the redemption of the ticket construct 50 for the amount of predetermined winnings as a single-use transaction. That is, the same ticket of a copy of the ticket with the unique confirmation code can only be redeemed once for a given game. The redemption winnings can take various forms including cash, credit, or additional plays.

Although the constructs 10 and 50 are depicted in the form of tickets, such as for use in gaming, the constructs can be used for a variety of purposes including for marketing and security interests. For example, the constructs could be used as on-demand printed coupons containing hidden codes, discount offerings, award points, or other information of interest to customers. Confirmation codes can be on-demand printed to validate authenticity or reference the intended contents of the marketing constructs.

Although the terminal 142 is described above as an interface with a player, a similar terminal can be operated on behalf of a player by a sales associate or other trained person to better assure its proper operation. Each of the ticket constructs could also be preprinted with an identification code that is pre-associated with the structure of the ticket including intended printing locations and a range or type of game intended for play. When read by the terminal, the identification code can govern or be matched to player selections. As unique numbers, the identification codes can be used in place of or in addition to the confirmation code and linked to a file or other record that can contain the player's chosen values, the stakes applied, the intermediate values, the outcome, and any award due to the player, as well as environmental information concerning the originating terminal 142 and the date and time of associated events such as the transmissions to and from the central processing system and the operation of the algorithm. Thus, the pre-printed code can be activated by the play and support a singular redemption of the ticket. Although the tickets are described as single-use for the purpose of preventing multiple redemptions of the same prize, each ticket can support more than one game. For example, dual-sided constructs as will be later described can include different games on the front and back of the tickets or can otherwise be dividable into more than one game, such as by dividing the ticket by a line of perforations. For example, multiple ticket stubs printed with intermediate results could be collected to achieve a winning combination entitling a player to another or “second-chance” award.

### Fractured Islands

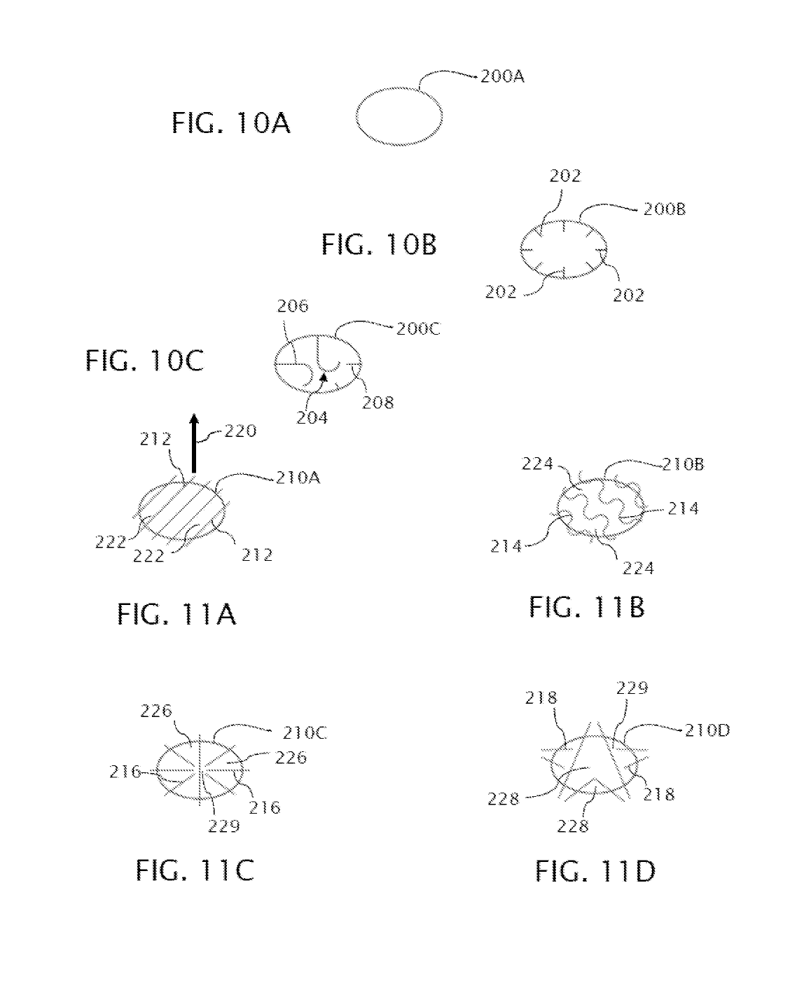

FIGS. 10A-10C show enlarged views of oval-shaped islands 200A through 200C, which are similar to the islands 90 of FIGS. 6A through 6C and which are formed in a cover substrate similar to the metallized film cover substrate 52 and are intended for being mounted on a base substrate similar to the thermally printable medium base substrate 54. The island 200A matches the die-struck (or otherwise cut) shape of the islands 90. However, the islands 200B and 200C are further modified to include respective internal die cuts 202 and 204. The internal die cuts 202 comprise radial segments extending through the oval-shaped periphery of the island 200B, breaking the periphery of the islands into individually removable segments that allow the island 200B to be more easily peeled from their underlying substrate in stages. The internal die cuts 204 include radial segments 206 similar to the die cuts 202 and other radial segments 208 that extend through the center of the island 200C and curl within a remaining space. While still facilitating peeling, the radial segments 208 further promote the removal of the island 200C in different stages. While the islands are described as being segmented by internal die cuts, the islands could be similarly segmented by other cutting mechanisms including laser cutting, which might be used alone or in combination with die cutting to produce smaller segments or segments with more unusual shapes.

FIGS. 11A-11D show similarly enlarged views of oval-shaped islands 210A through 210D. Again, the islands 210A through 210D are similar to the islands of FIGS. 6A through 6C in overall construction and also share the initial die-struck shape of the island 200A. However, the islands 210A through 210D are each subject to a second die strike for superimposing die-cuts 212, 214, 216, and 218 in different patterns. The second die strike can occur either before or after removal of a matrix comprising a remaining area of the cover substrate 52 surrounding the islands. As shown, the die struck patterns extend beyond the peripheries of the islands 210A through 210D for manufacturing convenience. The superimposed die-cuts 212 of island 210A comprise a set of equally spaced diagonal cuts that are inclined to a direction of expected relative movement of the construct with respect to a thermal printhead shown by arrow 220. The superimposed die cuts 214 of island 210B extend diagonally as a set of wavy lines. Both of the diagonal die cuts 212 and 214 extend through the oval-shaped peripheries of the islands 210A and 210B to divide the islands 210A and 210B into respective separately removable segments 222 and 224. The superimposed die cuts 216 of island 210C extend radially without intersecting at the center of the island 210C. Although one of the radial cuts bisects the island 210C, pie-shaped segments 226 on either side of the bisecting cut remain connected to each other through ties 229. While the pie-shaped segments 226 are individually peelable to support a progressive revealing of the underlying printing, two groups of the segments 226 on either side of the bisecting cut tend to remain interconnected upon removal from the underlying substrate. The superimposed die cuts 218 of island 210D form a star-shaped pattern that breaks the island 210D into a plurality of different size and shaped segments 228, some of which are interconnected by ties 229.

Another example of a thermally printable construct 230 in a truncated form and usable as a ticket or other conveyor of hidden information has the same basic construction as the construct 50 shown in FIGS. 6A-6C. For example, the depicted oval-shaped islands 210A through 210D are cut from a metallized film cover substrate, such as the cover substrate 52, and are removably mounted on a thermally printable medium base substrate 234 similar to the base substrate 54 via a clean-release adhesive. The remaining matrix of the cover substrate surrounding the islands 210A through 210D has been removed, leaving the islands 210A through 210D, although preferably only microns (e.g., 10 microns) thick, projecting above the base substrate 234.

The various islands 210A through 210D, which are variously distributed over the construct 230, are each separately peelable from the base substrate 234. However, the various fracture patterns of the islands 210A through 210D vary the manner in which the islands 210A through 210D are removed. Instead of peeling the respective islands 210A through 210D from the base substrate 234 as integral bodies, the fractured patterns produced by through die cuts and described with respect to FIGS. 11A through 11D promote the removal of the respective islands in stages. For example, the segments 222 and 224 of islands 210A and 210B are separately removable. That is, the pealing of one segment does not contribute to the concomitant removal of an adjoining segment. Thus, each segment is arranged to be separately pealed from the base substrate 234, so that multiple pealing actions are effected to completely remove one of the islands 210A or 210B. The multiple peeling actions provide for the progressive exposure of the underlying printed contents such as the hidden printed images 84 of FIGS. 6A through 6C. Although some measure of added effort may be associated with multiple peeling actions, the individual sections 222 and 224 are preferably more easily removable than a whole island that is not similarly fractured. Reducing the effort to remove individual segments combined with rewarding players by the progressive exposure of the hidden information as each segment is removed is believed to enhance the overall player experience more akin to a conventional latex/wax scratch-off coatings.

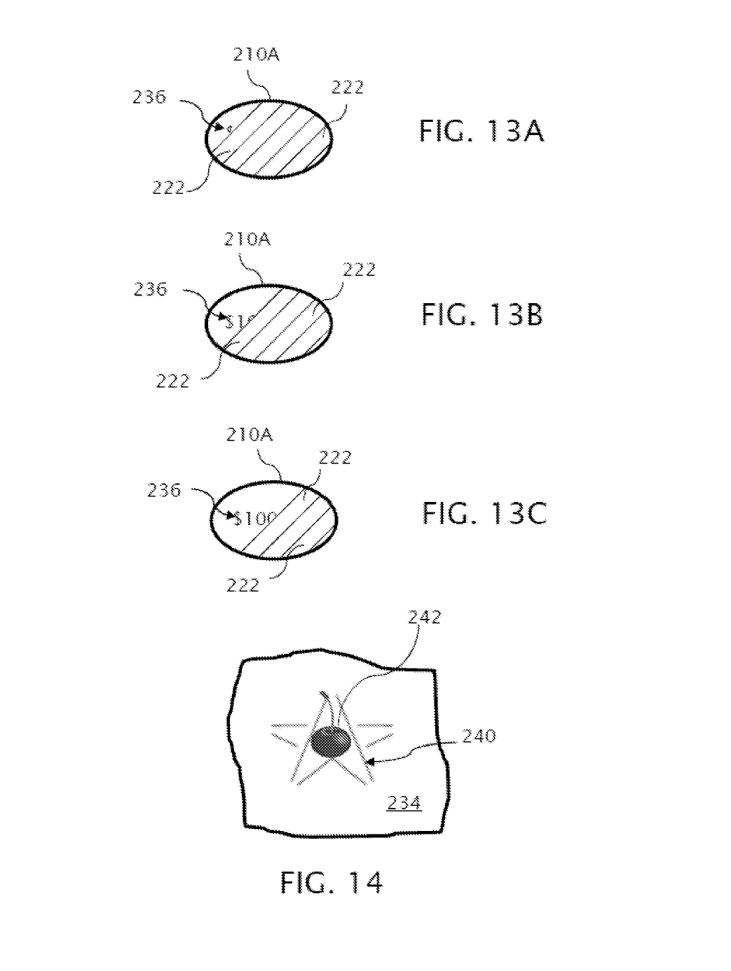

FIGS. 13A through 13C depict the successive removal of the segments 222 of the island 210A to progressively reveal an underlying printed image 236. Each of the segments removed either brings the player closer to revealing the printed image 236 or reveals progressively larger portions of the printed image 236. As shown, the individual segments 222 can be sized and shaped or otherwise registered with the contents of the printed image 236 so that the printed image 236 is revealed in predetermined stages or all at once following the removal of other segments.

Although at least some of the segments 226 and 228 of the islands 210C and 210D remain interconnected by ties 227 and 229, the segments 226 and 228 also tend to be separately removable from the base substrate 234 and as such can be subject to a separate peeling action for the progressive exposure of underlying printed information.

The die used to strike the fractured patterns can also be heated to thermally develop the fractured patterns on the underlying thermally printable medium base substrate 234. For example, as shown in FIG. 14 with the island 210D removed, the superimposed die cuts 218 of island 210D also print a corresponding star-shaped pattern 240 the base substrate 24 in registration with a printed image 242. Similar cutting and printing effects can be achieved by thermally induced laser cutting. The corresponding star-shaped pattern 240 could also be produced with an unheated die in the form of embossing.

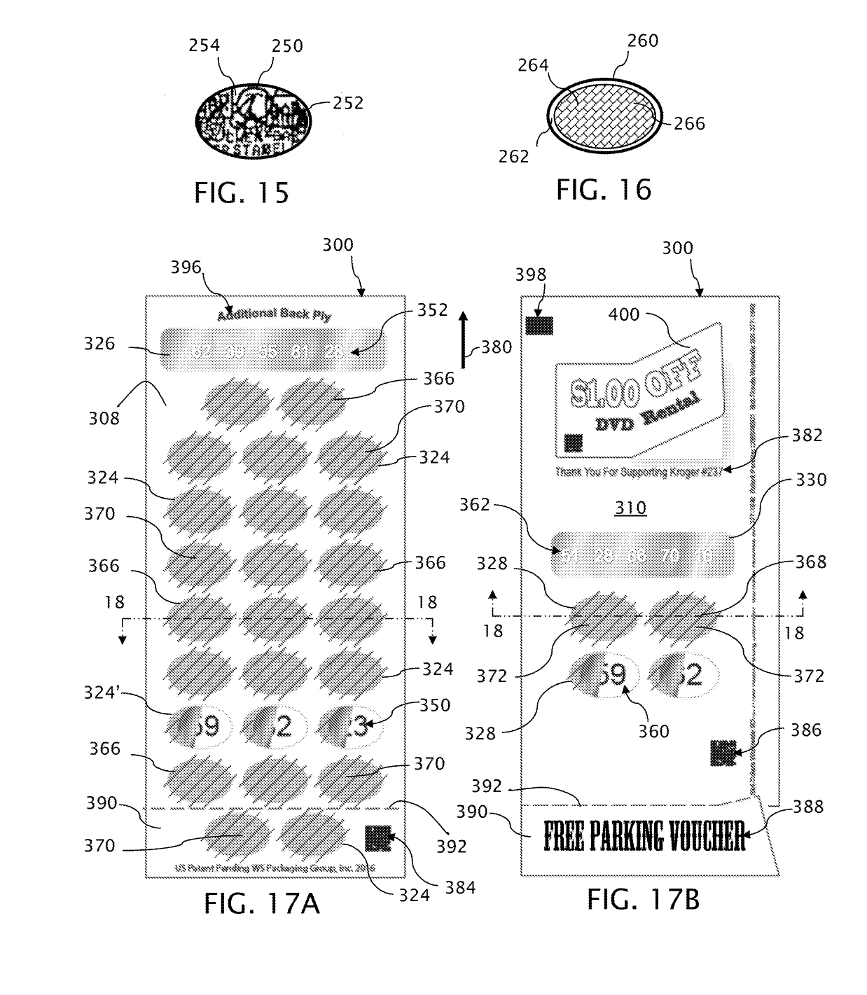

Other fracture patterns for islands 250 and 260 are shown in FIGS. 15 and 16. Island 250 of FIG. 15 has a fracture pattern of die cuts 252 representing a confusion pattern for further obscuring underlying printing and to disrupt candling through either side of the associated construct. The fracture pattern matches a conventional confusion pattern disclosed in U.S. Pat. No. 5,346,259 for a conventional “scratch-off” game ticket in which the conventional confusion pattern is printed within and internal layer. If necessary or otherwise preferred, the die cuts 252 can be formed by multiple strikes, preferably in registration with each other. One or more dies for forming the fracture pattern can also be heated for branding adjacent areas of the die cuts 252 to camouflage any expected branding effects from thermal printing. Similar cutting and branding effects can be achieved by thermally induced laser cutting, such as a 400 W Sealed CO₂ laser. In fact, laser cutting permits more flexibility for cutting irregular shapes and smaller size features. The resulting oddly shaped segments 254, while individually removable, can be scraped off the base substrate in a manner even more similar to conventional latex/wax coatings. Separate from the cutting operations, lasers can also be used to camouflage branding effects of thermal printing by modifying physical or optical characteristics of the film layer 314 of the cover substrate 302. For example, Ti:Sapphire lasers can be used to locally vary the refractive index of polymer materials in power domains exceeding the non-linear absorption threshold of the materials as described for example in U.S. Pat. No. 7,568,365, which is hereby incorporated by reference. Photo-sensitizers for absorbing actinic radiation can be incorporated into the film layer to improve processing efficiencies such as disclosed in U.S. Pat. No. 8,194,709, which is hereby incorporated by reference. Patterns of refractive index changes can be used to create diffraction or diffuse reflection patterns for obscuring branding effects. Within an adjacent slightly higher power energy regime, the lasers can be used to ablate patterns in the film layer such as disclosed in US Patent Application Publication No, 2004/0102765, which is also incorporated by reference. Laser power, particularly in the infrared spectrum, can be focused on the surface of the film layer to induce local thermal effects by heating similar to the branding effects of thermal printing and written in the form of confusion patterns or other obscuring patterns.

A confusion pattern could also be printed over or in advance of the die cuts 252 with one or more inks including combinations of inks that incorporate variations in reflectivity as described above. The ink patterns can cooperate with the fracture patterns to further protect the underlying printing from view. In addition to printing a confusion pattern over any one of the islands subject to fracturing, a layer of varnish can also be printed over any of the fractured islands in addition to or separate from the confusion pattern. The varnish layer, especially if applied subsequent to die cutting and by flood coating or registered pattern coating, can protect edges as well as the overall integrity of the segments 254 when subject to thermal printing or other expected use.

The island 260 of FIG. 16 is fashioned with a fracture pattern that includes a die cut forming an outer segment 262 as a protective ring. Within the protective ring, the remaining die cuts 264 crisscross to form a plurality of internal segments 266 of reduced size. The outer segment 262 in the form of a ring protects the internal segments from inadvertent removal during thermal printing or other expected use. The clean release adhesive patches holding the internal segments 266 to the base substrate match the reduced sizes of the internal segments and therefore exhibit correspondingly reduced holding forces. While the reduced holding forces are advantages to promoting the intended removal of the segments by deliberate peeling or scraping actions, some form of additional protection may be needed to keep the segments 266 in place until intentionally removed. For example, a stronger clean release adhesive could be used, the segments 266 could be over-coated with a protective layer such as varnish, and as shown in FIG. 16, an outer segment 262 can be formed as a protective ring so that the internal segments 266 are not exposed around the periphery of the island 260. Although the protective ring 262 is shown as an integral structure, judicious die cuts could also be made to divide the ring 262 into segments while still providing some additional measure of protection for the internal segments 266 of reduced size.

Although all of the examples of fractured islands are based on an oval shape, the fracture islands, like the islands described in the previous embodiments, can be formed in a variety of shapes, sizes, and distributions to suit the desired application. The segments of the fracture patterns can also be formed in a variety of different sizes and shapes, including as different sizes and shapes within individual islands. For example, to further replicate the experience of conventional latex/wax overcoatings, the segments of the fracture patterns could be reduced to mere specks, including segments sized to one square millimeter areas or less. The fracture patterns can also be coordinated with the peripheral shapes of the islands to be further representative of objects, such as stars, bullseyes, flowers, cars, trucks, and animals, where the internally cut lines contribute to the definitions of the objects. Certain of the internal segments could be removed to further contribute to the definition of objects or to provide windows offset from the intended locations of any information required to be obscured. The fracturing of the islands has also been described as a die cutting operation, but the relatively thin cover substrate, particularly in the form of a metallized film, could also be cut into segments by other means such as by laser cutting or other forms of etching. The so-called base substrate underlying the fractured islands has been described as a thermally printable medium but the fractured islands could be used with other media, including media known for use with scratch-off latex/wax coverings of preprinted information. In addition, the areas of the thermally printable medium base substrate beneath the islands can be preprinted in part on press during manufacture and later on-demand thermally printed through the islands.

### Double-Sided Direct Thermal Construct

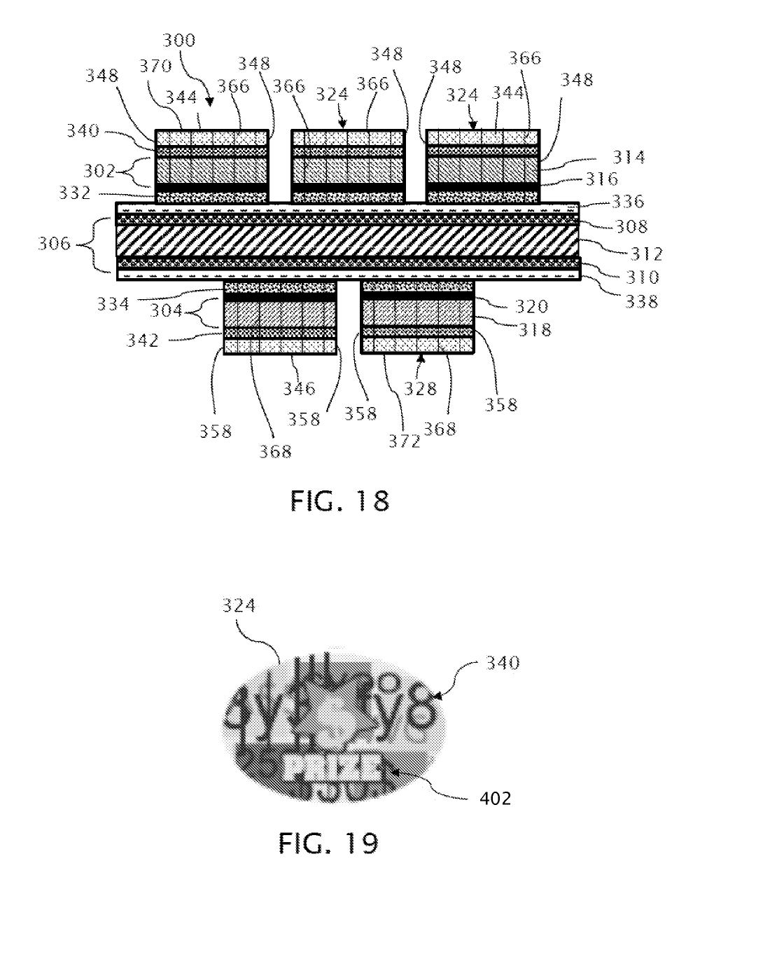

FIGS. 17A and 17B depict front and back views of another example of a direct thermal printable construct 300 in the form of a ticket or game piece. As further shown in the cross-sectional view of FIG. 18, the construct 300 is a double-sided direct thermal construct including front and back cover substrates 302 and 304, both in the form or a metallized film, covering portions of the front and back surfaces of a base substrate 306. A front thermosensitive imaging layer 308 is partly covered by the front cover substrate 302, and a back thermosensitive imaging layer 310 is partly covered by the back cover substrate 304. The two thermosensitive imaging layers 308 and 310 can be pre-applied to a paper or film backing 312 as a commercially available thermosensitive imaging stock or can be coated with a thermosensitive medium on one or both sides of the backing 312 over the same or more limited areas intended to be subject to direct thermal printing. Each of the thermosensitive imaging layers 308 and 310 can be arranged to support single or multiple color changes as a function of temperature or position on the base substrate 306.

The metallized film front cover substrate 302 includes a clear film 314 and a metallized layer 316 rendering the front cover substrate 302 substantially opaque. Similarly, the metallized film back cover substrate 304 includes a clear film 318 and a metallized layer 320 rendering the back cover substrate 304 substantially opaque. The paper or film backing 312 is also preferably substantially opaque as a result of its composition alone or in combination with an additional coating or printing.

Similar to the direct thermal printable construct 50, the metallized film front cover substrate 302 has been die cut and stripped leaving an array of front oval-shaped islands 324 and a single front rectangular-shaped island 326. The metallized film back cover substrate 304 has also been die cut and stripped leaving a smaller array of back oval-shaped islands 328 and a single back rectangular-shaped island 330. Also similar to the construct 50, the various islands 324, 326, 328, and 330 can be individually or collectively cut out or otherwise shaped in other forms and differently distributed within and among the front and back surfaces of the base substrate 306.

In addition, the front islands 324 and 326 and the back islands 328 and 330 are releasably bonded to the thermally printable medium base substrate 306 by respective clean-release adhesive layers, which can be formed by the combination of front and back cold glue layers 332 and 334 and front and back release layers 336 and 338, also similar to preceding embodiments. The cold glue layer 332 and the release layer 336 can be coated onto one or both of the front cover substrate 302 and the front of the base substrate 306, but one or the other of the layers 332 and 336, preferably the cold glue layer 332, is preferably coated just prior to laminating the two substrates 302 and 306 together. Similarly, the cold glue layer 334 and the release layer 338 can be coated onto one or both of the back cover substrate 304 and the back of the base substrate 306, but one or the other of the layers 334 and 338, preferably the cold glue layer 334, is preferably coated just prior to laminating the two substrates 304 and 306 together. As described above, the coatings can be applied in a variety of ways on press such as by printing plates or tint sleeves including by way of flood coating or pattern printing.

A front confusion pattern 340 is printed over a substantial portion of the front cover substrate 302 excluding an exposed portion, which is at least partially occupied by the front rectangular island 326 as shown in FIG. 17A. A back confusion pattern 342 is printed over a substantial portion of the back cover substrate 304 excluding an exposed portion, which is at least partially occupied by the back rectangular island area 330 as shown in FIG. 17B. A front varnish layer 344 containing matting agents preferably covers the front cover substrate 302 over top of the front confusion pattern 340 to provide a smooth surface for engaging a thermal printhead. A back varnish layer 346 containing matting agents preferably covers the back cover substrate 304 over top of the back confusion pattern 342 to provide a smooth surface for engaging a thermal printhead. Additional front and back confusion patterns can be printed on the metal film sides of the front and back cover substrates 302 and 304.

Die cuts 348 extend through the metallized film front cover substrate 302 forming a matrix that can be removed for presenting the metallized film front cover substrate 302 as a plurality of front islands 324 and 326 releasably mounted on the front surface of the thermally printable medium base substrate 306. Similarly, die cuts 358 extend through the metallized film back cover substrate 304 forming a matrix that can be removed for presenting the metallized film back cover substrate 304 as a plurality of back islands 328 and 330 releasably mounted on the back surface of the thermally printable medium base substrate 306. While the die cuts 348 and 358 can be arranged to form indentations in the thermally printable medium base substrate 306, the die cuts 348 and 358 preferably stop short of penetrating the base substrate 306. The front islands 324 and 326 of the front cover substrate 302 are similarly exposable to a thermal printhead for on-demand printing by a thermal printer. The back islands 328 and 330 of the back cover substrate 304 are similarly exposable to a thermal printhead for on-demand printing by the same or another thermal printer. Two-sided or duplexed thermal printers can be used for thermally printing both sides of the construct 300 at once.

For example, the metallized film front cover substrate 302, together with the front confusion pattern and varnish layers 340 and 344 on the front cover substrate 302, and the front cold glue and release layers 332 and 336 of the clean-release adhesive, is arranged to be thermally transmissive, and the thermal printhead applies localized heat and pressure through the respective transmissive layers to induce a thermal response in the underlying front thermosensitive imaging layer 308 resulting in the formation of printed images 350 matching the applied pattern of thermal energy. The printed images 350 in the front thermosensitive imaging layer 308 remain hidden behind the front islands 324 and 326 of the metallized film front cover substrate 302 until the front islands 324 and 326 are peeled back as shown for example, in FIG. 17A as the islands 324′. Preferably, the slightly raised front islands 324 and 326 are peelable apart from the thermally printable medium base substrate 306 by a scraping or scratching action, such as by using a fingernail, coin, or other tool, for having the effect of providing scratch-off coverings for the underlying printed images 350.

In a similar way, the metallized film back cover substrate 304, together with the back confusion pattern and varnish layers 342 and 346 on the back cover substrate 304, and the back cold glue and release layers 334 and 338 of the clean-release adhesive, is arranged to be thermally transmissive, and the same or another thermal printhead applies localized heat and pressure through the respective transmissive layers to induce a thermal response in the underlying back thermosensitive imaging layer 310 resulting in the formation of printed images 360 matching the applied pattern of thermal energy.

In addition to producing thermally induced printed images 350 and 360, the same thermal printing operations can be used to produce thermally induced printed images 352 and 362 in the exposed surfaces of the front and back islands 326 and 330 that are not covered by the confusion patterns 340 and 342 via the phenomenon referred to as “branding.” Although both sets of printed images 350, 352 and 360, 362 are induced by comparable amounts of localized heat and pressure applied by a thermal printhead to the outer surfaces of the metallized film front and back cover substrates 302 and 304, the printed images 352 and 362 are formed by different mechanism than the printed images 350 and 360. Instead of inducing a color change in a thermosensitive medium, the heat and pressure applied to the clear films 314 and 318 supporting the underlying metallized layers 316 and 320 locally change the reflectivity characteristics of the metallized film front and back cover substrates 302 and 304. Untreated, the metallized film front and back cover substrates 302 and 304 are substantially specularly reflective. The referenced thermal printing, however, renders the locally affected portions exposed to the heat and pressure of the printhead substantially more diffuse. Accordingly, light is reflected differently, i.e., more diffusely, from the locally affected portions with respect to the light that is reflected from the remaining exposed portion of the metallized film front and back cover substrates 302 and 304, producing the necessary contrast for rendering the printed images 352 and 362 visible. The printed images 352 and 362 can appear lighter or darker than the remainder of the exposed portions of the islands 326 and 330 depending on the position of an observer with respect to a light source illuminating the exposed surfaces of the metallized film front and back cover substrates 302 and 304.

Similar to the confusion pattern 68 of the construct 50, which is printed over the portion of the front surface 72 of the metallized film cover substrate 52 occupied by the islands 90, the confusion patterns 340 and 342 are preferably printed over one or more portions of the front and back cover substrates 302 and 304 occupied by the front and back islands 324 and 328. In addition, the front and back confusion patterns 340 and 342 are preferably printed with multiple inks or varnishes that exhibit different reflective characteristics within a range that varies optically from specular to diffuse and expressed in the ink or varnish within a range from high gloss through semi-gloss, satin, and eggshell to flat. Preferably, one of the inks or varnishes is a high gloss or semi-gloss mimicking the more specular reflective properties of the metallized film front and back cover substrates 302 and 304 that have not been subject to thermal printing and another of the inks or varnishes is a satin or eggshell mimicking the more diffuse reflective properties of the areas of the metallized film front and back cover substrates 302 and 304 that have been subject to thermal printing. In addition, the two or more inks or varnishes exhibiting different reflective properties can be of the same color including no color at all. For example the printed inks of the confusion pattern can be printed with an ink having a color of white to gray for further limiting contrast with a metallized film containing a layer of aluminum. The two or more inks or varnishes that exhibit differing reflectivity characteristics can be printed in complementary patterns occupying pluralities of juxtaposed regions or can be printed one over the other in different patterns.

The enlarged view of FIG. 19 shows an example of one of the islands 324 overprinted with both the confusion pattern 340 and overlying graphics 402 for labeling the island. The confusion pattern 340 is shown with lines, characters, and shades in different levels of gloss to obscure any thermal effects of thermal printing through the island and to thwart attempts at “candling.” The graphics 402 indicate that something of value may be printed beneath the island.

While not shown, additional confusion patterns can be printed on inside surfaces of metallized film front and back cover substrates 302 and 304 on the metallized films 316 and 320. The additional confusion patterns are preferably printed with an ink designed to further obscure the printed images 350 and 360 formed in the front and back thermosensitive imaging layers 308 and 310, particularly as a countermeasure to thwart “candling.” The color and pattern of the ink is selected to mimic the type of contrast between the printed images 350 and 360 and the remainder of the thermosensitive imaging layers 308 and 310 as may be apparent through the construct 300. For example, at least one color among the inks of the additional confusion patterns can be matched to the appearance of the dyes released in the printed front and back thermosensitive imaging layers 308 and 310 to obscure the corresponding color changes in the printed thermosensitive imaging layers 308 and 310. The confusion patterns can also be printed in multiple overlapping or spatially differentiated colors corresponding to multiple color changes in the printed front and back thermosensitive imaging layers 308 and 310 over the same or different areas. As such, lines and shapes, and in particular characters, of the printed images 350 and 360 become largely indistinguishable from the lines and shapes of the additional confusion patterns during “candling.” Alternatively, the additional confusion patterns can be printed on the front and back thermosensitive imaging layers 308 and 310. If the metallized film cover substrates 302 and 304 or the thermally printable medium base substrate 306 are sufficiently substantially opaque to light being shined through the construct 300, one or both of the additional confusion patterns may be unnecessary to prevent “candling.”

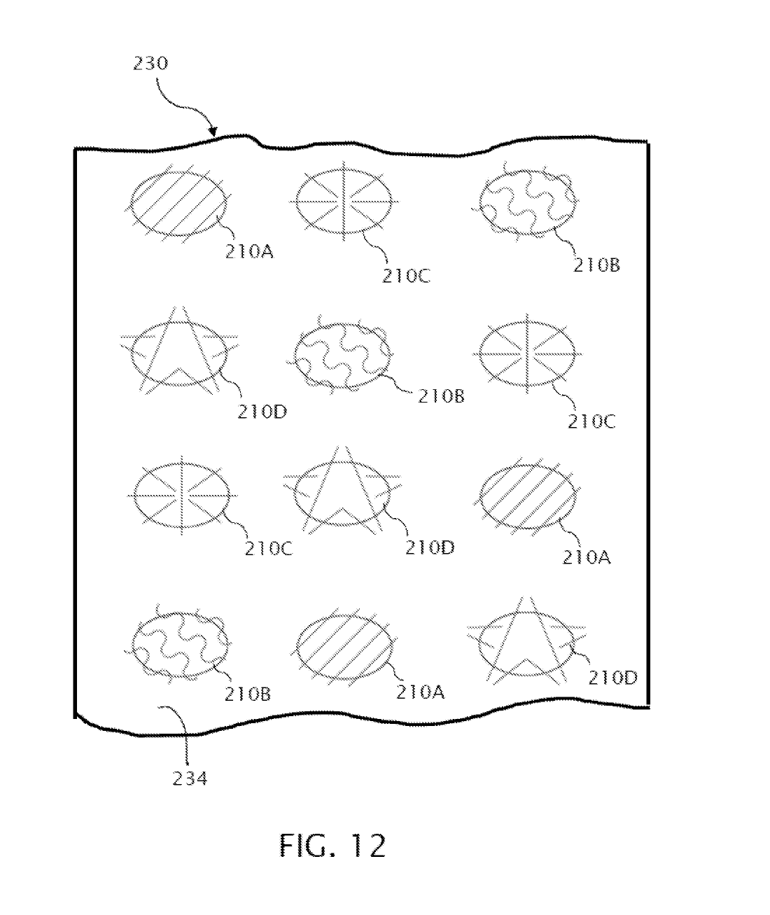

Similar to the fractured islands shown in FIGS. 10A-10C, 11A-11D, 12, 13A-13C, 14, and 15, the islands 324 and 328 are further modified to include fracture patterns formed by respective die cuts 366 and 368 that extend through the front and back cover substrates 302 and 304 and break the front and back islands 324 and 328 into individually removable segments 370 and 372 that allow the islands 324 and 328 to be more easily pealed from the thermally printable base substrate 306 in stages. As shown, the die cuts 366 and 368 extend beyond the peripheries of the islands 324 and 328 for manufacturing convenience, indenting without substantially penetrating the base substrate 306 and comprising a set of equally spaced diagonal cuts 366 and 368 that are inclined to a direction of expected relative movement of the construct 300 with respect to a thermal printhead shown by arrow 380.

Just as the front and back islands 324 and 328 can be formed in various shapes as described above, the fracture patterns by which the islands 324 and 328 are divided into individually peelable segments 370 and 372 can also be varied as shown and described with respect to FIGS. 10A-10C, 11A-11D, 12, 13A-13C, 14, and 15. Single or multiple die cuts are preferably used to form the islands and their various fracture patterns on either side of the construct 300, but the islands could also be cut out of the front and back cover substrates 302 and 304 and separated into segments by other means such as by laser cutting or etching. Preferably, the front and back varnish layers 344 and 346 are applied after the fracture patterns are formed in the front and back islands 324 and 328 to help hold the segments 370 and 372 in place and to present a more continuous surface for thermal printing. Additionally, the front and back varnish layers 344 and 346 can be applied to the base substrate 306 after removing the matrix, especially in areas of the base substrate 306 adjacent to the front and back islands 324, 326 and 328, 330 so that the varnish layers 344 and 346 overlap the peripheries of the front and back islands 324, 326 and 328, 330 to help hold the islands in place and to present a more continuous surface for thermal printing.

The exposed portions of the thermally printable base substrate 306, i.e., portions not covered by the islands 324, 326, 328, and 330 or other substrates, can be direct thermally printed on demand together with or separately from the direct thermal printing through the islands 324, 326, 328, and 330. Examples of such direct thermal printing include (a) a responsive message such as the message 382 appearing on the back of the thermally printable base substrate 306, (b) matrix barcodes 384 and 386 appearing on the front and back of the thermally printable base substrate 306, and an offer, reward, or further game play such as the “free parking” offer 388 appearing on a detachable stub 390.

The matrix barcodes 384 and 386 can be used to register or record information concerning the construct 300 as a ticket or game piece, link the ticket or game piece to a wireless network, open a web page, or provide for other interactive activities. As a registered game piece, one or both of the matrix barcodes 384 and 386 can be read for authenticating or redeeming winning tickets.

The detachable stub 390 can be formed by a line of perforation 392 that extends through the base substrate 306 and separates the stub 390 from the remainder of the construct 300. The possible uses for the detachable stub 390 include a further or second-chance game piece that can be collected with other similar detachable stub game pieces to assemble a potentially winning or otherwise redeemable set of game pieces. For example, the front islands 324 located below the line of perforation 392 can be used to temporarily hide information relevant to an additional game. The matrix barcode 384 can be associated with the stub 390 as a confirmation code associated with its thermally printed contents.

Conventional, e.g., non-thermal, text or graphics can be preprinted on the base substrate 306 or elsewhere including on the islands 324 and 328 to provide instructions, color graphics and logos, or other substantive or decorative graphics. In addition, identification codes or registration marks for operations including die cutting operations and subsequent direct thermal printing through the islands 324, 326, 328, and 330 can be printed on the base substrate 306 by thermal or non-thermal means. By way of example, instructions 396 are preprinted on the front of the base substrate 306 and a registration mark 398 is preprinted on the back of the base substrate 306. The preprinted registration mark 398 can be used to register the intended direct thermal printing locations on both the front and back of the construct 300, including the direct thermal printing through the islands 324, 326, 328, and 330.

Further exploiting the clean release adhesive that can be applied to the base substrate 306, a removable coupon 400 or other independent piece can also be mounted on the base substrate 306. The removable coupon 400 can be preprinted on one or both sides with desired text or graphics and can include its own thermosensitive imaging layer on its exposed side surface for on-demand printing together with or separately from the on-demand printing of other portions of the construct 300. The coupon 400 preferably comprises a separate and more substantial substrate that is similarly releasably bonded to the base substrate by the same clean release adhesive that temporarily bonds the islands or another pattern coated clean release adhesive adapted for temporarily bonding the more substantial substrate. Alternatively, the coupon 400 can be mounted on a film or other intermediate substrate affixed to the base substrate. One side of the film or other intermediate substrate can be permanently affixed to the base substrate, particularly on a side or area of a base substrates that is not arranged with a thermosensitive imaging layer or a clean release adhesive, and the other side of the film or other intermediate substrate can support a clean release adhesive for temporarily mounting the removable coupon. The film or other intermediate substrate can be transparent for revealing underlying printing on the base substrate, or regardless of its transparency, the film or underlying substrate can be conventionally printed to reveal additional text or graphics that become visible upon the removal of the coupon 400.

### Metallized Film

The metallized film cover substrates 12, 52, 302 and 304 are preferably a polymer film coated with a thin layer of metal, such as aluminum. Such films offer the glossy metallic appearance of an aluminum foil at a reduced weight and cost. Such metallized films are widely used for decorative purposes and food packaging, and also for specialty applications including insulation and electronics.

Metallization can be utilized to form highly opaque yet very thin layers. Metal layers have the advantage of supporting good thermal conductivity between the thermal printheads and interleaving layers until the thermal energy reaches a thermally responsive ink that changes color state in response to printing.

Biaxially-oriented polyethylene terephthalate (boPET) is a polyester film made from stretched polyethylene terephthalate (PET) and is used for its high tensile strength, chemical and dimensional stability, transparency, reflectivity, gas and aroma barrier properties and electrical insulation. A variety of companies manufacture boPET and other polyester films under different trade names. In the US and Britain, well-known trade names include Mylar, Melinex, and Hostaphan. Biaxially oriented PET film can be metallized by vapor deposition of a thin film of evaporated aluminum, gold, or other metal onto it. As much as 99% of light, including much of the infrared spectrum, is reflected by such films.

Physical vapor deposition (PVD) is a form of vacuum deposition and is a general term used to describe any of a variety of methods to deposit thin films by the condensation of a vaporized form of the material onto various surfaces. The coating method involves purely physical processes such as high temperature vacuum evaporation or plasma sputter bombardment rather than involving a chemical reaction at the surface to be coated as in chemical vapor deposition.

Variants of PVD of interest include but are not limited to various processes in which the material to be deposited is heated to a high vapor pressure by electrically resistive heating in “low” vacuum. Electron beam physical vapor deposition involves heating the target material to be deposited to a high vapor pressure by electron bombardment in “high” vacuum. Sputter deposition involves a glow plasma discharge (usually localized around the target material by a magnet) that bombards the target material, sputtering some away as a vapor. Cathodic Arc Deposition involves a high-power arc directed at the target material, which blasts away some of the target material into a vapor. Pulsed laser deposition involves a high-power laser that ablates material from the target into a vapor.

PVD is used in the manufacture of items including semiconductor devices, aluminized PET film for balloons and snack bags, and coated cutting tools for metalworking. Besides PVD tools, special smaller tools have been developed mainly for scientific purposes. They mainly serve the purpose of extremely thin films measured in atomic layers and are used mostly for small substrates. Mini e-beam evaporators, for example, can deposit monolayers of virtually all materials with melting points up to 3500° C.

Metallized, including holographic or prismatic, thin films provide a combination of high opacity, facile thermal diffusion, and conductivity between the printheads and printable medium, affordability and commercial availability, ability to be further printed for informational purposes, and ease of use in high speed automated printing and manufacturing processes.

Metallized films can include but are not limited to vapor deposited films, sputtered films, metal coated films, pure cast or formed foil films, printed metal films, embossed or laminated metal films and the like. The metal layer can range in practical thickness depending on the printers capabilities. High energy printers can accommodate thicker films and metal layer whereas lower energy print units will only be able to accommodate thin films with good thermal transfer properties.

Metallized layers coated on plastic resin-based films can range from over 100 microns to a few molecular layers of metal depending on the required parameters for printing and product constructs. Usually, metallized layers will range between 50 microns and 0.5 nanometers. More often metal layers will range 10 microns to 1 nanometer. Typically, metal layers will find use between 1 micron and 2 nanometers.

Metallized Mylar and/or polyester films including both the metallized substantially opaque layer and supporting plastic resin-based film exhibit favorable properties of being thin, present good thermal transfer characteristics, do not adversely affect the performance of a thermal printheads in a thermal printing unit, have the strength and integrity to act as a robust laminate in on-demand secured printing articles, can be utilized with commercial printing and processing presses and equipment, are affordable for the applications of interest, are highly obscuring and do not readily reveal printed information in a secured printed article, are visually appealing, may be further printed on the exposed side with ancillary information for use, are flexible and can be readily manipulated, and have good adhesion characteristics between the resin substrate and the metal layer such that the film is stable to adhesives and laminating process necessary for making functional articles. Tints can also be added to the supporting films to change the apparent color of the metallized film. For example, a yellow tint can change the color of a metallized aluminum film to gold. The choice of color can also be used to match underlying thermal printing as a further way to obscure the underlying printing.

For thermal printing units that deliver moderate to low temperatures and printing energies, it is desirable to use thin highly responsive obscuring films. In other cases when printing units are utilized that operate at higher printing temperatures and energies, it is feasible to utilize thicker less responsive obscuring films.

Obscuring metallized films can find use in the range of 2 microns to 500 microns in thickness when including an obscuring metal component and the film resin component. Often, films will be utilized in the range between 3 microns and 250 microns. More often, films ranging between 4 microns and 100 microns. Usually films possessing adequate integrity, commercial availability, and properties for the application will range between 5 microns and 50 microns in film thickness. Metallized films in the 8 to 10 micron range have been found to provide adequate strength and thermal conductivity for an embodiment of this invention.

Supporting film compositions can include, but are not limited to plastic resins such as Mylar based films, polyesters, extruded polyesters, BOPP, PET, polypropylene, polyethylene, and nylon. The films can also be selected on the basis of heat stabilization to minimize any effects of branding, particularly for thermally printing through islands intended for hiding color changes in an underlying thermosensitive medium.

### Thermosensitive Imaging Layer

The thermosensitive imaging layers 20, 60, 308 can take a variety of known forms. For example, polymeric inks can be tuned to be used with thicker or thinner substantially opaque obscuring films for printing on an underlying substrate, e.g., the base substrates 14, 54, 234, and 306. A triggering transition temperature can be formulated from room temperature to over 300° F. Tunable polymeric inks can be formulated at a convenient transition temperature to enable the construct of interest and to select a thermal printer of interest.

Compatible systems for generating color development reversibly, irreversibly, from colorless to a colored state based on ascending temperature, from a colored state to a colorless state based on descending temperature, solvation, hydration, or other chemical and physical stimuli to a colored state to a colorless state during the stimuli. Color transitions can be with and without color change hysteresis, including abrupt or broad transition color change options, utilize micro-encapsulation processes or un-encapsulated processes, and can find use in a wide range of applications. Natural product food-grade color developers are available for both ascending and descending color change compositions. Combinatorial chemistries, including leuco dye color formers and polydiacetylenic-based compounds, can serve as developers and possess their own intrinsic color change properties.

Polymeric ink formulations can be pre-polymerized and set at a given temperature setting for a pre-formulated ink or can be produced in a monomeric form and polymerized in-line and prior to assembly of an on-demand secured printed construct. In either case, the temperature setting and approach for formulation and polymerization provide for flexibility of adapting the temperature setting and dynamic or static sensitivity for a range of product applications of interest.

Pre-polymerized ink formulations can be conveniently prepared in aqueous ink vehicles. Aqueous ink formulations have the benefit of avoiding undesirable volatile solvents that most result in environmental concerns upon evaporation. Pre-polymerized aqueous ink are prepared by emulsifying monomeric diacetylenic compositions either in the crystalline state to a micro-particulate state or by forming an oil phase above the melting transition of the monomer and aggressively mixing the composition to a stable micro-emulsion form.

Aqueous vehicles can be selected for particular applications depending on their utility and compatibility with particular diacetylenic monomeric compounds. Upon adequate emulsification and particle sizing, the diacetylenic composition can be polymerized by using 254 nanometer ultraviolet light from a colorless to an enriched blue coloration typical and indicative of the polydiacetylene polymerization reaction. Alternatively, polymerization can be accomplished by using a gamma irradiation source of other compatible high-energy source such as cobalt 60.

Formulated polymeric inks can be used directly with commercial printing process, but importantly will need to be adjusted in viscosity, surface tension, surfactant loading, temperature setting, particle sizing, and ancillary component content depending on the application of interest. Similarly, stabilizing agents, preservatives, and anti-oxidants can be used for improved shelf-life and stability.

Monomeric components can generally be added at between 0.1% and up to 50% by weight. Usually, monomeric components will be added between 1% and 30% by weight to the final ink composition. More often, they will be added between 5% and 20% by weight. The exact concentration and monomeric composition depends on such factors as the desired loading, coloration intensity required, anilox roller loading, and printing method.

Solvent-based diacetylenic inks find use where it is practical to formulate a solvent based ink with dissolved diacetylenic monomers. Solvents provide for maintaining monomers in the dissolved state. When solvent based monomeric diacetylenic inks are printed and dried, the drying process facilitates the rapid and homogenous crystallization of the diacetylenic monomer. Once the monomeric solvent base ink has been printed and dried, the ink can be polymerized from a colorless state to a color blue state typical and illustrative of the formation of the polydiacetylenic polymer backbone.

The degree of polymerization can be utilized to adjust the temperature transition of the polymer color change thereby providing a convenient method to tune the ink temperature setting depending on the application of interest. By way of example, selected long chain diacetylenic compounds can be tuned in temperature form 120° F. to 200° F. depending on the level of polymerization. Uses and application diacetylenic and polydiactylenic compounds are well described elsewhere (Ribi U.S. Pat. Nos. 5,918,981 and 5,685,641).

Pigmented polymeric inks can be used with slightly thicker substantially opaque obscuring films for printing on the back side of the obscuring film or with thin obscuring films for printing on the underlying substrate. Commercially available irreversible pigmented thermochromic inks can be utilized in on-demand secured printed documents provided that the temperature transition, dynamic sensitivity and static sensitivities are suitable for the particular application of interest. Irreversible thermochromic inks can be sourced from commercial sources (e.g. Segan Industries, Inc. or Nucoat, Inc.) or prepared accordingly (Ribi, WO2008079357 A2) as well as other commercial sources.

Tunable compositions can be micro-encapsulated or non-micro-encapsulated depending on the application of interest. Encapsulate species provide the inherent robustness for many matrices or mediums such as plastics, certain paints, or robust coatings. Un-micro-encapsulated species provide a lower cost means to utilize said compositions where the compositions can be administered to a product application in fewer less costly steps. Various permutations of encapsulated on un-encapsulated tunable color generation compositions can be utilized. By way of example, but not limitation, developers and color formers can both be un-encapsulated. Alternatively, the developer can be encapsulated whereas the color former may be un-encapsulated. In another example, the developer may be un-encapsulated whereas the color former may be encapsulated. In addition, varying degrees of encapsulation may be utilized by one component or another.

Typically, irreversible pigmented thermochromic inks exhibit temperature thresholds in the range between 40° C. and 120° C. Usually, transition temperatures will find use between 50° C. and 110° C. with temperature transition in the range between 60° C. and 100° C. most favored. Irreversible pigmented inks can be formulated to adhere to and printed on the inner side of the substantially opaque film layer or on the surface of the apposing substrate layer of the construct. Pigmented adjustable irreversible color change inks provide flexibility for use in various construct configurations and uses with different thickness of substantially opaque obscuring layers.

### Direct Thermally Printable Media

Static sensitivity should be considered when selecting a direct thermal substrate for on-demand secured printing. Static sensitivity indicates the temperature at which a thermal paper will begin imaging. Thermal papers with low static sensitivity only begin imaging at high temperatures; thermal papers with higher static sensitivity begin imaging much earlier (between 70 and 75° C.).

Dynamic sensitivity of thermal papers indicates how fast a thermal paper can be printed. This is especially relevant in the selection of the right thermal paper for a particular thermal printer, since the higher the dynamic sensitivity of the paper, the faster the printer can operate without any settings having to be changed. In mobile printers that typically operate at slower speeds than desktop printers, dynamic sensitivity is often less important than static sensitivity.

The sensitivity of a thermal paper refers to the degree to which it reacts to heat (energy). A high sensitivity product will generally create a better image than a low sensitivity product when given less heat or energy. Images that need to be rich and dark generally require a high sensitivity thermal paper.

Paper sensitivity can be measured on a dynamic sensitivity curve, which is an X-Y graph that measure energy in mill joules vs. density. A fully developed thermal image will typically be 1.2 density reading or greater. The dynamic sensitivity curve shows how fast a thermal paper will image or print. This can be especially important when selecting the thermal printer, since the higher the dynamic sensitivity of the paper, the faster the printer is able to operate. Dynamic sensitivity curves are available for a complete range of thermal papers.

Direct thermal printed papers including, but not limited to commercially available papers from major suppliers and manufactures. Direct thermal papers and films most readily adjusted will be those with thermal compositions and coating amenable to localized changes that can be introduced by introduction and interaction of the adhesive overlay. The intended up-shift or downshift in thermal characteristics of the direct thermal transfer substrate will depend on the intended application of interest, the degree of temperature change intended and the time intended for introducing and optical change in the substrate.

Less thermally active or sensitive thermal commercially papers and films can find use as acceptably active color generating substrates by using sensitizing coatings coated on top of or transferred to the top of the direct thermal substrate. Marginally active direct thermal printing substrates can be increased in sensitivity by applying a sensitizing layer to either the surface of the direct thermal printing substrate or through a thermal transfer ink that carries and delivers a sensitizing agent to the surface of the direct thermal transfer layer during the process of secured on-demand printing.

Likewise, acceptably active direct thermal substrate and thicker less thermally responsive obscuring layers or films can find use particularly if a sensitizing agent is utilized in conjunction with a combined less active direct thermal substrate/obscuring layer. In either case, sensitizing agents can be utilized that improve the sensitivity of commercially available materials thereby increasing the range of available obscuring/opaque layers, direct thermal substrates, and thermally active ink compositions.

While the above description references certain embodiments in detail, it will be understood that variants of these embodiments and other features and functions and alternatives thereof may be combined into may other different systems or applications. As such, various presently unforeseen or unanticipated alternatives, modifications, variations or improvements therein may be subsequently made by those skilled in the art, which are also intended to be encompassed by the following claims.

1. A direct thermal printable construct comprising:
a cover substrate comprising a metallized film;
a base substrate comprising a thermally printable medium including a thermosensitive imaging layer subject to color change by thermal printing;
the cover substrate being divided into a plurality of islands of metallized film that are individually releasably bonded to the thermosensitive imaging layer of the base substrate;
the base substrate includes first areas that are covered by the plurality of islands of the metallized film and a second area that is not covered by the plurality of islands of the metallized film;
the thermosensitive imaging layer being thermally printable by exposing the plurality of islands of metallized film to localized heat and pressure of a thermal printhead for inducing local changes in the color of the thermosensitive imaging layer that are obscured from view by the plurality of islands of metallized film; and
the plurality of islands of metallized film being individually peelable apart from the base substrate for revealing the local changes in the color of the thermosensitive imaging layer.

2. The direct thermal printable construct of claim 1 in which the plurality of islands of metallized film are releasably bonded to the base substrate by a clean-release adhesive, which is arranged together with the metallized film for transmitting heat from a thermal printer for producing the color changes in the thermosensitive imaging layer.

3. (canceled)

4. The direct thermal printable construct of claim 1 in which at least some of the islands of metallized film are overprinted by a confusion pattern having varying reflectivity characteristics for obscuring local changes in the reflectivity of the metallized film associated with the localized heat and pressure of a thermal printhead.

5. The direct thermal printable construct of claim 4 in which the confusion pattern is formed by two or more inks having different levels of gloss.

6. The direct thermal printable construct of claim 1 in which the second area of the thermosensitive imaging layer that is not covered by the islands of metallized film is thermally printable by exposing the thermosensitive imaging layer to localized heat and pressure of the thermal printhead for inducing local changes in the color of the thermosensitive imaging layer that are not obscured from view by the plurality of islands of metallized film.

7. The direct thermal printable construct of claim 1 in which the plurality of islands of metallized film includes a first set of islands that are overprinted by a confusion pattern and at least one additional island that is not overprinted by a confusion pattern, and the at least one additional island is thermally printable by the exposure to the localized heat and pressure of the thermal printhead for inducing local changes in the reflectivity of the metallized film of the at least one additional island.

8. (canceled)

9. (canceled)

10. (canceled)

11. The direct thermal printable construct of claim 1 further comprising a printable substrate releasably bonded to the second area of the base substrate.

12. (canceled)

13. (canceled)

14. The direct thermal printable construct of claim 1 in which one or more of the islands are divided into a plurality of island sections that are individually releasably bonded to the thermosensitive imaging layer of the base substrate and are individually peelable apart from the base substrate.

15. (canceled)

16. The direct thermal printable construct of claim 14 in which at least some of the island sections of the one or more islands are interconnected by ties so that the interconnected sections remain tied together upon their removal from the base substrate.

17. The direct thermal printable construct of claim 14 in which at least some of the island sections of the one or more islands are formed as closed shapes disconnected from other island sections of each of the one or more islands so that the disconnected sections are removable as individual pieces from the base substrate.

18. The direct thermal printable construct of claim 14 further comprising a registration mark on the direct thermal construct for referencing intended print locations in the thermosensitive imaging layer, and in which the island sections of the one or more islands are sized and registered with the intended print locations so that different island sections of each of the one or more of the islands are arranged to cover different portions of the local changes in the color of the thermosensitive imaging layer obscured from view by each of the one or more islands.

19. (canceled)

20. The direct thermal printable construct of claim 14 in which the island sections of the one or more of the islands are divided by a plurality of cut lines that together form a fraction pattern that is arranged to provide a confusion pattern that obscures effects of thermal printing through the one or more islands.

21. The direct thermal printable construct of claim 14 in which each of the one or more of the islands includes a peripheral shape and the island sections within the peripheral shape of the one or more islands are divided by a plurality of cut lines through the cover substrate.

22. (canceled)

23. (canceled)

24. (canceled)

25. (canceled)

26. (canceled)

27. The direct thermal printable construct of claim 21 further comprising a layer of varnish coated over the one or more of the islands including over the plurality cut lines that divide the one or more islands into sections.

28. The direct thermal printable construct of claim 1 in which the cover substrate is a first of two cover substrates with the plurality of islands being individually releasably bonded to the thermosensitive imaging layer on one side of the base substrate, a second of the two cover substrates is divided into one or more islands of metallized film that are individually releasably bonded to a thermosensitive imaging layer on an opposite side of the base substrate, and the thermosensitive imaging layer on the opposite side of the base substrate is thermally printable by exposing the one or more islands of metallized film of the second cover substrate to localized heat and pressure of a thermal printhead, and the one or more islands of metallized film of the second cover substrate are individually peelable apart the base substrate.

29. (canceled)

30. (canceled)

31. (canceled)

32. (canceled)

33. (canceled)

34. (canceled)

35. (canceled)

36. The direct thermal printable construct of claim 1 in which each of the plurality of islands includes peripheral shape and at least some of the plurality of islands are relatively displaced from one another so as to be separated by exposed portions of the base substrate.

37. The direct thermal printable construct of claim 1 further comprising a line of perforation through the base substrate forming a portion of the base substrate as a removable stub and at least one additional island of metallized film is releasably bonded to the removable stub of the base substrate, and in which the base substrate of the removable stub includes a thermosensitive imaging layer that is thermally printable by exposing the at least one additional island of metallized film on the removable stub to localized heat and pressure of a thermal printhead for inducing local changes in the color of the thermosensitive imaging layer on the removable stub that are obscured from view by the at least one additional island of metallized film on the removable stub, and the at least one additional island of metallized film on the removable stub is peelable apart from the removable stub for revealing the local changes in the color of the thermosensitive imaging layer on the removable stub.

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. A method of making a direct thermal printable construct comprising steps of:
advancing a first web comprising a thermally printable medium along an in-line press;
advancing a second web comprising a metallized film along the in-line press;
applying a clean release adhesive between the first and second webs and laminating the first and second webs together;
cutting through the second web to form a plurality of islands within a removable matrix; and
stripping the removable matrix of the second web from the first web, leaving the islands collectively supported on the first web,
wherein the step of cutting includes cutting within the islands to thereby form a plurality of sections that are at least partially separated by cuts from other sections within the islands, and
wherein the sections cut within the islands are individually peelable apart from the first web.

55. (canceled)

56. (canceled)

57. The method of claim 54 in which the cutting step includes a first cutting operation for forming the islands and a second cutting operation for at least partially forming the sections within the islands, and in which the step of stripping takes place between the first and second cutting operations.

58. (canceled)

59. The method of claim 54 including a step of printing indicia on the first web in locations corresponding to the islands intended to be cut through the second web and registering a cutting operation for forming the islands according to the cutting step with the indicia printed on the first web.

60. The method of claim 54 including a step of applying a varnish over at least the cut islands of the second web to provide a common surface overlapping the cut sections within the individual islands.

61. (canceled)

62. (canceled)

63. (canceled)

64. A direct thermal printable construct comprising:
first and second substantially opaque substrates straddling a thermosensitive imaging layer;
a clean-release adhesive layer releasably bonding the two substrates together;
the first substrate comprising a metallized film;
a confusion pattern printed over a first area of the metallized film leaving a second area of the metallized film exposed;
the thermosensitive imaging layer being printable by exposing the first and second areas of the metallized film to localized heat and pressure of a thermal printhead for inducing local changes in the color of the thermosensitive imaging layer; and
the second area of the metallized film being printable by the exposure of the second area of the metallized film to the localized heat and pressure of the thermal printhead for inducing local changes in the reflectivity of the metallized film,
wherein the local color changes of the thermosensitive imaging layer and the local reflectively changes of the metallized film are achievable at the same power settings of the thermal printhead.

65. (canceled)

66. The direct thermal printable construct of claim 64 in which the metallized film comprises a metallized layer on an at least partially transparent film, and the film forms a front surface on which the confusion pattern is printed over the first area, and on which the local changes in reflectively are printed over the second area.

67. The direct thermal printable construct of claim 66 in which the confusion pattern incorporates variations in reflectivity to obscure the local reflectivity changes in the metallized film.

68. (canceled)

69. (canceled)

70. The direct thermal printable construct of claim 64 in which the base substrate includes two regions separated by a perforation pattern; the clean-release adhesive being applied to one of the two regions, and a more permanent adhesive being applied to the other of the two regions for forming a tab to assist with removal of the metallized film after printing.

71. (canceled)

72. A method of printing a laminated construct having an internal on-demand thermally printable layer hidden between first and second substantially opaque substrates, comprising steps of:
directing the laminated thermal construct through a thermal printer having a printhead in contact with a front surface of the first substantially opaque substrate in the form of a metallized film;
applying heat and pressure with the printhead to a first portion of the front surface of the metallized film covered by a confusion pattern for inducing local color changes in the internal on-demand thermally printable layer; and
applying heat and pressure with the same printhead to a second portion of the front surface of the metallized film that is not covered by the confusion pattern for inducing local reflectivity changes in the metallized film.

73. The method of claim 72 in which the step of applying heat and pressure with the printhead to the first portion of the front surface of the metallized film covered by the confusion pattern includes applying the heat and pressure through a clean-release adhesive layer releasably bonding the metallized film to the second substantially opaque substrate, and in which the local color changes of the thermosensitive imaging layer and the local reflectively changes of the metallized film are obtained at the same power settings of the thermal printhead.

74. (canceled)

75. (canceled)

76. (canceled)

77. An interactive gaming system comprising:
a gaming terminal with communications link to a processing system;
the gaming terminal including an interface for accepting inputs concerning a game to be played, including selections originating from a player;
the processing system being arranged for receiving the inputs from the gaming terminal over the communications link, executing a gaming algorithm corresponding to the game to be played with a computer processor, and transmitting intermediate results of the algorithm to the gaming terminal;
the gaming terminal being arranged for receiving the intermediate results over the communications link and advancing a direct thermal printable construct for printing;
the direct thermal printable construct including a cover substrate comprising a metallized film, and a base substrate comprising a thermally printable medium having a thermosensitive imaging layer subject to color change by thermal printing; and
the gaming terminal being further arranged to include a thermal printer for thermally printing both (a) the player selections on the direct thermal printable construct in a form that can be viewed on a face of the construct and (b) the intermediate results through the cover substrate for producing color changes in the thermosensitive imaging layer that are obscured from view by the cover substrate, and for dispensing the thermally printed construct.

78. The interactive gaming system of claim 77 in which the processing system is connected by communication links to a plurality of gaming terminals, and in which the processing system is further arranged for storing the inputs from the gaming terminal and the intermediate results generated by the gaming algorithm as a basis for determining if the player is entitled to an award.

79. (canceled)

80. The interactive gaming system of claim 78 in which the processing system associates a unique confirmation code with the stored inputs and intermediate results and transmits the unique confirmation code to the gaming terminal, and the gaming terminal thermally prints the confirmation code on the construct.

81. The interactive gaming system of claim 80 in which the gaming terminal is further arranged for receiving the printed construct for redemption including incorporating a reader for reading the confirmation code on the printed construct.

82. (canceled)

83. The interactive gaming system of claim 77 in which the cover substrate of the construct is divided into a plurality of islands of metallized film that are individually releasably bonded to the thermosensitive imaging layer of the base substrate, and the gaming terminal is arranged to thermally print the intermediate results through the plurality of islands, and in which the plurality of islands of metallized film are individually peelable apart the base substrate for revealing the intermediate results as local changes in the color of the thermosensitive imaging layer.

84. (canceled)

85. The interactive gaming system of claim 83 in which one or more of the plurality of islands of metallized film includes a peripheral shape and island sections within the peripheral shape that are divided by a plurality of cut lines through the cover substrate and that are individually peelable apart from the base substrate.
